(19) United States
(12) Patent Application Publication
(10) Pub. No.: US 2011/0246409 A1
(43) Pub. Date: Oct. 6, 2011

(54) DATA SET DIMENSIONALITY REDUCTION PROCESSES AND MACHINES

(75) Inventor: Sushmita Mitra, Kolkata (IN)

(73) Assignee: INDIAN STATISTICAL INSTITUTE, Kolkata (IN)

(21) Appl. No.: 12/784,403

(22) Filed: May 20, 2010

(30) Foreign Application Priority Data
Apr. 5, 2010 (IN) 379/KOL/2010

(51) Int. Cl. G06N 7/02; G06F 17/18; G06F 17/30

(52) U.S. Cl. 706/52; 702/179; 707/822; 707/E17.005

(57) ABSTRACT

Provided in part herein are processes and machines that can be used to reduce a large amount of information into meaningful data and reduce the dimensionality of a data set. Such processes and machines can, for example, reduce dimensionality by eliminating redundant data, irrelevant data or noisy data. Processes and machines described herein are applicable to data in biotechnology and other fields.

### RELATED PATENT APPLICATION

This patent application claims the benefit of Indian patent application no. 379/KOL/2010, filed Apr. 5, 2010, naming Sushimita Mitra as inventor, entitled DATA SET DIMENSIONALITY REDUCTION PROCESSES AND MACHINES, and having attorney docket no. IVA-1004-IN (IN-700600-02-US-REG). The entirety of this patent application is incorporated herein, including all text and drawings.

### FIELD

Technology provided herein relates in part to processes and machines for generating a reduced data set representation. Processes and machines described herein can be used to process data pertinent to biotechnology and other fields.

### SUMMARY

Featured herein are methods and processes, apparatuses, and computer programs for reducing dimensionality of a data set. In one aspect provided is a method for reducing dimensionality of a data set including: receiving a first data set and a second data set, choosing a feature selection, performing statistical analysis on the first data set by one or more algorithms based on the feature selection, determining a statistical significance of the statistical analysis based on the second data set, and generating a reduced data set representation based on the statistical significance.

Also provided is a computer readable storage medium including program instructions which when executed by a processor cause the processor to perform a method for reducing dimensionality of a data set including: receiving a first data set and a second data set, choosing a feature selection, performing statistical analysis on the first data set by one or more algorithms based on the feature selection, determining a statistical significance of the statistical analysis based on the second data set, and generating a reduced data set representation based on the statistical significance.

Also provided is a computer method that reduces dimensionality of a data set performed by a processor including: receiving a first data set and a second data set, choosing a feature selection, performing statistical analysis on the first data set by one or more algorithms based on choice of the feature selection, determining a statistical significance of the statistical analysis based on the second data set, and generating a reduced data set representation based on the statistical significance.

Also provided is an apparatus that reduces the dimensionality of a data set including a programmable processor that implements a data set dimensionality reducer where the reducer implements a method including, receiving a first data set and a second data set, choosing a feature selection, performing statistical analysis on the first data set by one or more algorithms based on choice of the feature selection, determining a statistical significance of the statistical analysis based on the second data set, and generating a reduced data set representation based on the statistical significance. In some embodiments, the apparatus includes memory. In certain embodiments, one or more of the first data set, the second data set and the dimensionality reducer are stored in the memory. In some embodiments, the processor includes circuitry for accessing a plurality of data residing on a data storage medium. In certain embodiments, the apparatus includes a display screen and a user input device both operatively in conjunction with the processor.

Also provided is a computer program product that when executed performs a method for grouping genes including: acquiring gene expression data and gene ontology data, choosing a feature selection, clustering the gene expression data into gene clusters, determining a statistical significance on the clustered gene expression data based on the gene ontology data, repeating the clustering of the gene expression data and the determining the statistical significance until substantially all genes have been clustered, repeating the choosing the feature selection, the performing the statistical significance, and the determining the statistical significance at least once after completion of the repeating the clustering the gene expression data, where a different feature selection is chosen; generating a graph of a reduced data set based on the statistical significance; and validating the reduced data set with an algorithm. In certain embodiment, clustering the gene expression data into gene clusters is performed by an algorithm. In some embodiments, a graph of a reduced data set is generated based on the statistical significance.

Also provided is a method for generating a reduced data set representation, the method including: receiving by a logic processing module a first data set and a second data set, choosing by a data organization module a feature selection, performing by the logic processing module statistical analysis on the first data set utilizing one or more algorithms based on the feature selection, determining by the logic processing module a statistical significance of the statistical analysis based on the second data set, generating by a data display organization module a reduced data set representation based on the statistical significance, and storing the reduced data set representation in a database. In certain embodiments, the method is implemented in a system, wherein the system comprises distinct software modules embodied on a computer readable storage medium. In some embodiments, performing the statistical analysis and the determining the statistical significance are repeated until substantially all genes have been clustered. In certain embodiments, choosing the feature selection, performing the statistical analysis and determining the statistical significance are repeated at least once after substantially all genes have been clustered, where a different feature selection is chosen.

Also provided is a computer program product, including a computer usable medium having a computer readable program code embodied therein, the computer readable program code adapted to be executed to implement a method for generating a reduced data set representation, the method including: receiving, by a logic processing module, a first data set and a second data set, choosing by a data organization module a feature selection, performing by the logic processing module statistical analysis on the first data set utilizing one or more algorithms based on the feature selection, determining by the logic processing module a statistical significance of the statistical analysis based on the second data set, and generating by a data display organization module a reduced data set representation based on the statistical significance. In some embodiments, the performing the statistical analysis and the determining the statistical significance are repeated until substantially all genes have been clustered. In certain embodiments, the choosing the feature selection, the performing the statistical analysis and the determining the statistical significance are repeated at least once after substantially all genes have been clustered, where a different feature selection is chosen.

Also provided is an apparatus that reduces the dimensionality of a data set including a programmable processor that implements a computer readable program code, the computer readable program code adapted to be executed to perform a method for generating a reduced data set representation, the method including: receiving, by the logic processing module, a first data set and a second data set, choosing a feature selection by the data organization module in response to being invoked by the logic processing module, performing statistical analysis on the first data set utilizing one or more algorithms based on the feature selection by the logic processing module, determining a statistical significance of the statistical analysis based on the second data set by the logic processing module, and generating a reduced data set representation based on the statistical significance by the data display organization module in response to being invoked by the logic processing module. In some embodiments, the apparatus includes memory. In certain embodiments, one or more of the first data set, the second data set and the dimensionality reducer are stored in the memory. In other embodiments, the apparatus includes other features previously mentioned. In some embodiments, the processor includes circuitry for accessing a plurality of data residing on a data storage medium. In certain embodiments, the apparatus includes a display screen and a user input device both operatively in conjunction with the processor. In some embodiments, the performing the statistical analysis and the determining the statistical significance are repeated until substantially all genes have been clustered. In certain embodiments, the choosing the feature selection, the performing the statistical analysis and the determining the statistical significance are repeated at least once after substantially all genes have been clustered, where a different feature selection is chosen.

In certain embodiments, the first data set is selected from the group including gene microarray expression data, gene ontology data, protein expression data, cell signaling data, cell cycle data, amino acid sequence data, nucleotide sequence data, protein structure data, and combinations thereof. In some embodiments, the second data set is selected from the group including of microarray expression data, gene ontology data, protein expression data, cell signaling data, cell cycle data, amino acid sequence data, nucleotide sequence data, protein structure data, and combinations thereof. In certain embodiments, the first data set, second data set, or first data set and second data set are normalized. In some embodiments, the first data set, the second data set, or the first data set and the second data set are normalized by a normalization technique selected from the group including of Z-score of intensity, median intensity, log median intensity, Z-score standard deviation log of intensity, Z-score mean absolute deviation of log intensity, calibration DNA gene set, user normalization gene set, ratio median intensity correction, and intensity background correction.

In certain embodiments, the feature selection is selected from the group including of genes, gene expression levels, florescence intensity, time, co-regulated genes, cell signaling genes, cell cycle genes, proteins, co-regulated proteins, amino acid sequence, nucleotide sequence, protein structure data, and combinations thereof. In some embodiments, the one or more algorithms performing the statistical analysis is selected from the group including of data clustering, multivariate analysis, artificial neural network, expectation-maximization algorithm, adaptive resonance theory, self-organizing map, radial basis function network, generative topographic map and blind source separation. In certain embodiments, the algorithm is a data clustering algorithm selected from the group including of CLARANS, PAM, CLATIN, CLARA, DBSCAN, BIRCH, OPTICS, WaveCluster, CURE, CLIQUE, K-means algorithm, and hierarchical algorithm. In some embodiments, the clustering algorithm is CLARANS, the first data set is gene microarray expression data, the second data set is gene ontology data, and the feature selection is genes. In certain embodiments, the statistical significance is determined by a calculation selected from the group including of comparing means test decision tree, counternull, multiple comparisons, omnibus test, Behrens-Fisher problem, bootstrapping, Fisher's method for combining independent tests of significance, null hypothesis, type I error, type II error, exact test, one-sample Z test, two-sample Z test, one-sample t-test, paired t-test, two-sample pooled t-test having equal variances, two-sample unpooled t-test having unequal variances, one-proportion z-test, two-proportion z-test pooled, two-proportion z-test unpooled, one-sample chi-square test, two-sample F test for equality of variances, confidence interval, credible interval, significance, meta analysis or combination thereof.

In some embodiments, the statistical significance is measured by a p-value, which is the probability for finding at least k genes from a particular category within a cluster of size n, where f is the total number of genes within a category and g is the total number of genes within the genome in the equation

$$p = 1 - {\sum }_{i = 0}^{k - 1} \frac{( \begin{matrix}f \\ i\end{matrix} ) ( \begin{matrix}g - f \\ n - i\end{matrix} )}{( \begin{matrix}g \\ i\end{matrix} )} .$$

In certain embodiments, the performing the statistical analysis and the determining the statistical significance are repeated after the determining the statistical significance until substantially all of the first data set has been analyzed.

In some embodiments, the method further includes repeating the choosing the feature selection, the performing the statistical analysis and the determining the statistical significance at least once after completion of the generating the reduced data set representation, where a different feature selection is chosen. In certain embodiments, the method further includes after the determining the statistical significance, identifying outliers from the first data set and repeating the performing the statistical analysis and determining the statistical significance at least once or until substantially all of the outliers have been analyzed. In some embodiments, the reduced set removes redundant data, irrelevant data or noisy data. In certain embodiments, a reduced data set representation is selected from the group including of digital data, a graph, a 2D graph, a 3D graph, and 4D graph, a picture, a pictograph, a chart, a bar graph, a pie graph, a diagram, a flow chart, a scatter plot, a map, a histogram, a density chart, a function graph, a circuit diagram, a block diagram, a bubble map, a constellation diagram, a contour diagram, a cartogram, spider chart, Venn diagram, nomogram, and combination thereof. In some embodiments, the method further includes, after the performing the statistical analysis, validating the statistical analysis on the first data set.

In certain embodiments, the method further includes, after the generating the reduced data set representation, validating the reduced data set representation with an algorithm. In some embodiments, the method further includes validating the analyzed outliers. In certain embodiments, the algorithm is selected from the group including of Silhouette Validation method, C index, Goodman-Kruskal index, Isolation index, Jaccard index, Rand index, Class accuracy, Davies-Bouldin index, Xie-Beni index, Dunn separation index, Fukuyama-Sugeno measure, Gath-Geva index, Bezdek partion coefficient or a combination thereof.

In certain embodiments, the modules often are distinct software moldules.

The foregoing summary illustrates certain embodiments and does not limit the disclosed technology. In addition to illustrative aspects, embodiments and features described above, further aspects, embodiments, and features will become apparent by reference to the drawings and the following detailed description and examples.

### BRIEF DESCRIPTION OF THE DRAWINGS

The drawings illustrate embodiments of the technology and are not limiting. For clarity and ease of illustration, the drawings are not made to scale and, in some instances, various aspects may be shown exaggerated or enlarged to facilitate an understanding of particular embodiments.

FIG. 1 shows an operational flow representing an illustrative embodiment of operations related to reducing dimensionality.

FIG. 2 shows an optional embodiment of the operational flow of FIG. 1.

FIG. 3 shows an optional embodiment of the operational flow of FIG. 1.

FIG. 4 shows an optional embodiment of the operational flow of FIG. 1.

FIG. 5 shows an illustrative embodiment of a system in which certain embodiments of the technology may be implemented.

### DETAILED DESCRIPTION

In the following detailed description, reference is made to the accompanying drawings, which form a part hereof. In the drawings, similar symbols typically identify similar components, unless context dictates otherwise. Illustrative embodiments described in the detailed description, drawings, and claims do not limit the technology. Some embodiments may be utilized, and other changes may be made, without departing from the spirit or scope of the subject matter presented herein. It will be readily understood that aspects of the present disclosure, as generally described herein, and illustrated in the drawings, can be arranged, substituted, combined, separated, and designed in a wide variety of different configurations, all of which are explicitly contemplated herein.

Certain data gathering efforts can result in a large amount of complex data that are disorganized and not amenable for analysis. For example, certain biotechnology data gathering platforms, such as nucleic acid array platforms for example, often give rise to large amounts of complex data that are not conducive to analysis. With new scientific discoveries and the advent of new, efficient experimental techniques, such as DNA sequencing, an exponential growth of vast quantities of information are being collected, such as genome sequences, protein structures, and gene expression levels. While database technology enables efficient collection and storage of large data sets, technology provided herein facilitates human comprehension of the information in this data. Enormous amounts of data from various organisms are being generated by current advances in biotechnology. Using this information to ultimately provide treatments and therapies for individuals requires an in-depth understanding of the gathered information. The challenge of facilitating human comprehension of the information in this data is growing ever more difficult. Another challenge is to combine data from different technology types in resultant data sets that are meaningful.

Data generated by these and other platforms in biotechnology and other industries often include redundant, irrelevant and noisy data. The data also often includes a high degree of dimensionality. It has been determined that analyzing two or more data sets along with statistical analysis and feature selections can efficiently and effectively eliminate redundant data, irrelevant data and noisy data. Such approaches can reduce a large amount of information into meaningful data, thereby reducing the dimensionality of a data set and rendering the data more amenable to analysis.

Technology provided herein can be utilized to identify patterns and relationships, and makes useful sense of some or all the information in a computational approach. When dealing with large amounts of data, where the volume is expansive in terms of relationships, connections, dependence and the like, such data may be multi-dimensional or high-dimensional data. Technology provided herein can reduce the dimensionality and can accomplish regression, pattern classification, and/or data mining which may be used in analyzing the data to obtain meaningful information from it. For example, reducing dimensionality often selects features that best represent the data. Data mining often applies methods to the data and can uncover hidden patterns. Choice of data analysis may depend upon the type of information a user is seeking from data at hand. For example, a reason for using data mining is to assist in the analysis of collections of observations of behavior. Choice of data analysis also may depend on how a user interprets data, predict its nature, or recognize a pattern.

### Datasets

Data sets may encompass any type of collection of data grouped together, which include, but are not limited, to microarray expression data, gene ontology, nominal data, statistical data, protein expression data, cell signaling data, cell cycle data, amino acid sequence data, nucleotide sequence data, protein structure data, genome databases, protein sequence databases, protein structure databases, protein-protein data, signaling pathways databases, metabolic pathway databases, meta-databases, mathematical model databases, real time PCR primer databases, taxonomic database, antibody database, interferon database, cancer gene database, phylogenomic databases, human gene mutation database, mutation databases, electronic databases, wiki style databases, medical database, PDB, DBD, NCBI, MetaBase, Gene bank, Biobank, dbSNP, PubMed, Interactome, Biological data, Entrez, Flybase, CAMERA, NCBI-BLAST, CDD, Ensembl, Flymine, GFP-cDNA, Genome browser, GeneCard, HomoloGene, and the like.

A nucleic acid array, or microarray in some embodiments, often is a solid support to which nucleic acid oligonucleotides are linked. An address at which each oligonucleotide is linked often is known. A polynucleotide from a biological source having a sufficient degree of sequence complementarity to a oligonucleotide at a particular address may hybridize (e.g., bind) to that oligonucleotide. Hybridized polynucleotides can be detected by any method known in the art, and in some embodiments, a signal indicative of hybridized polynucleotide at a particular address on the array can be detected by a user. In some embodiments, the signal may be fluorescent, and sometimes is luminescent, radioisotope emission, light scattering and the like. A signal can be converted to any other useful readout, such as a digital signal, intensity readout and the like, for example. Processes and machines described herein also are applicable to other data gathering formats, such as antibody arrays, protein arrays, mass spectrometry platforms, nucleic acid sequencing platforms and the like, for example.

Protein expression may be assayed with regards to apoptosis, antibody identification, DNA methylation, epigenetics, histology, tissue culture, cell signaling, disease characterization, genetics, bioinformatics, phenotyping, immunohistochemistry, in situ hybridization, molecular protocols, forensics, biochemistry, chemistry, physics, pathology, SDS-PAGE, and the like, for example. Expression of a protein may be characterized by the presence of certain ligands which can be seen by an antibody-receptor interaction, for example. Protein expression may also be characterized by presence of a phenotype, for example. Proteins may be characterized according to primary (amino acid), secondary (alpha helix, beta sheet), tertiary (3-D structure) and/or quaternary (protein subunits) protein structure, for example. Protein structure also may be characterized by basic elements, such as, for example, carbon, hydrogen nitrogen, oxygen, sulfur and the like. Interactions within a protein may also be considered such as, for example, hydrogen bonding, ionic interactions, Van Der Waals forces, hydrophobic packing. Structural information may be presented in terms of data generated from X-ray, crystallography, NMR spectroscopy, dual polarisation interferometry analyses and the like.

Cell signaling data may be presented in any suitable form and can be from any applicable cell signaling pathway (e.g., cell cycle pathways, receptor signaling pathways). Certain non-limiting examples are a listing of various proteins within a specific signaling pathway of certain cells, identifying signaling pathways from cells that affect other signaling pathways, and identifying similar/different molecules that activate or inhibit specific receptors for certain signaling pathways. Cell signaling data may be in the form of complex multi-component signal transduction pathways that involve feedback, signal amplification and interactions inside one cell between multiple signals and signaling pathways. Intercellular communication may be within any system, including the endocrine system, for example, and involve endocrine, paracrine, autocrine, and/or juxtacrine signals and the like. Various proteins involved within a cell signaling pathways may be included, such as, for example, a receptor, gap junction, ligand, ion channel, lipid bilayer, hydrophobic molecule, hydrophilic molecule, a homone, a pharmacological stimuli, kinase, phosphotase, G-protein, ion, protease, phosphate group, and the like.

Data sets may include any suitable type of data. Data may be included from flow cytometry, microarrays, fluorescence labeling of the nuclei of cells and the like. Nucleotide sequence data may be determined by techniques such as cloning, electrophoresis, fluorescence tagging, mass spectrometry and the like.

In some embodiments, data sets may include gene ontologies. Ontologies provide a vocabulary for representing and communicating knowledge about a topic, and a set of relationships that hold among the terms of the vocabulary. They can be structurally complex or relatively simple. Ontologies can capture domain knowledge that can be addressed by a computer. Because the terms within an ontology and the relationships between the terms are carefully defined, the use of ontologies facilitates making standard annotations, improves computational queries, and can support the construction of inference statements from the information at hand in certain embodiments. An ontology term may be a single named concept describing an object or entity in some embodiments. A concept may, for example, include a collection of words and associated relevance weights, co-occurrence and word localization statistics that describe a topic, for example. In various disciplines, scientific or otherwise, a number of resources (e.g., data management systems) may exist for representing cumulative knowledge gathered for different specialty areas within each discipline. Some existing systems, for instance, may use separate ontologies for each area of specialty within a particular discipline.

Certain data sets are larger and require pre-processing in some embodiments, and sometimes data sets require pre-processing for further analysis. Genomic sequencing projects and microarray experiments, for example, can produce electronically-generated data flows that require computer accessible systems to process the information. As systems that make domain knowledge available to both humans and computers, bio-ontologies such as but not limited to gene ontologies, anatomy ontologies, phenotype ontologies, taxonomy ontologies, spatial reference ontologies, enzyme ontologies, cell cycle ontologies, chemical ontologies, cell type ontologies, disease ontologies, development ontologies, environmental ontologies, plant ontologies, animal ontologies, fungal ontologies, biological imaging ontologies, molecular interaction ontologies, protein ontologies, pathology ontologies, mass spectrometry ontologies, and the many other bio-ontologies that can be generated and are useful for extracting biological insight from enormous sets of data.

Gene ontologies may support various domains such as but not limited to molecular function, biological process, and cellular component, for example. These three areas may be considered independent of one another in some embodiments, or sometimes can be considered in combination. Ontologies that include all terms falling into these domains, without consideration of whether the biological attribute is restricted to certain taxonomic groups, sometimes are developed. Therefore, biological processes that occur only in plants (e.g. photosynthesis) or mammals (e.g. lactation) often are included.

Examples of molecular functions, include, but are not limited to, addition of or removal of one of more of the following moieties to or from a protein, polypeptide, peptide, nucleic acid (e.g., DNA, RNA): linear, branched, saturated or unsaturated alkyl (e.g., C₁ to C₂₄ alkyl); phosphate; ubiquitin; acyl; fatty acid, lipid, phospholipid; nucleotide base; hydroxyl and the like. Molecular functions also include signaling pathways, including without limitation, receptor signaling pathways and nuclear signaling pathways. Non-limiting examples of molecular functions also include cleavage of a nucleic acid, peptide, polypeptide or protein at one or more sites; polymerization of a nucleic acid, peptide, polypeptide or protein; translocation through a cell membrane (e.g., outer cell membrane; nuclear membrane); translocation into or out of a cell

organelle (e.g., Golgi apparatus, endoplasmic reticulum, nucleus, mitochondria); receptor binding, receptor signaling, membrane channel binding, membrane channel influx or efflux; and the like. Non-limiting examples of biological processes include meiosis, mitosis, cell division, prophase, metaphase, anaphase, telophase, interphase, apoptosis, necrosis, chemotaxis, generating or suppressing an immune response, and the like. Other non-limiting examples of biological processes include generating or breaking down adenosine triphosphate (ATP), saccharides, polysaccarides, fatty acids, lipids, phospholipids, sphingolipids, glycolipids, cholesterol, nucleotides, nucleic acids, membranes (e.g., cell plasma membrane, nuclear membrane), amino acids, peptides, polypeptides, proteins and the like. Non-limiting examples of cellular components include organelles, membranes and others.

The structure of a gene ontology, for example, can be described in terms of a graph or a descriptive graph, where each gene ontology term is a node, and the relationships between the terms are arcs between the nodes. Relationships used in a gene ontology may be directed in certain embodiments. In a directed gene ontology relationship, a graph often is acyclic, meaning that cycles are not allowed in the graph (e.g., a mitochondrion is an organelle, but an organelle is not a mitochondrion). An ontology may resemble a tree hierarchy in some embodiments. Child terms often are more specialized and parent terms often are less specialized. A term may have more than one parent term in some embodiments, unlike a hierarchy. For example, the biological process term hexose biosynthetic process may have two parents, hexose metabolic process and monosaccharide biosynthetic process. The two branches, or parents, is delineated because biosynthetic process is a type of metabolic process and a hexose is a type of monosaccharide.

Data sets may be received or downloaded onto a computer or processor by any known method such as for example, via the internet, via wireless access, via hardware such as a flash drive, manual input, voice recognition, laser scanned, bar code scan, and the like. Data sets also may be generated while being received or come already packaged together. One data set that may be received may have homologous information, such as genes from the same organism, or heterologous information, such as genes and proteins from different organisms. One or more data sets may also be utilized as well as homologous and heterologous types of data sets. Data sets may also include overlapping data from another data set. A data set of samples, e.g., genes, can include any suitable number of samples, and in some embodiments, a set has about 10, 15, 20, 25, 30, 35, 40, 45, 50, 55, 60, 65, 70, 75, 80, 90, 100, 200, 300, 400, 500, 600, 700, 800, 900 or 1000 samples, or more than 1000 samples. The set may be considered with respect to samples tested in a particular period of time, and/or at a particular location and/or a particular organism or combination thereof. The set may be partly defined by other criteria, for example, age of an organism. The set may be included of a sample which is subdivided into subsamples or replicates, all or some of which may be tested. The set may include a sample from the same subject collected at two different time points.

Data sets may also be pre-processed, standardized or normalized to conform to a particular standard. For example, a pre-processing step sometimes aids in normalizing data when using tissue samples since there are variations in experimental conditions from microarray to microarray. Normalization can be carried out in a variety of manners. For example, gene microarray data can be normalized across all samples by subtracting the mean or by dividing the gene expression values by the standard deviation to obtain centered data of standardized variance.

A normalization process can be applied to different types of data. To normalize gene expression across multiple tissue samples, for example, the mean expression value and standard deviation for each gene can be computed. For all the tissue sample values of a particular gene, the mean can be subtracted and the resultant value divided by the standard deviation in some embodiments. In certain embodiments, an additional preprocessing step can be added by passing the data through a squashing function to diminish the importance of the outliers. This latter approach is also referred to as the Z-score of intensity.

Another example of normalization is applying a median intensity normalization protocol in which raw intensities for all spots in each sample are normalized by the median of the raw intensities. For microarray data, the median intensity normalization method can normalize each hybridized sample by the median of the raw intensities of control genes for all of the spots in that sample, for example.

Another example of a normalization protocol is the log median intensity protocol. In this protocol, raw expression intensities, for example, are normalized by the log of the median scaled raw intensities of representative spots for all spots in the sample. For microarray data, for example, the log median intensity method normalizes each hybridized sample by the log of median scaled raw intensities of control genes for all of the spots in that sample. Control polynucleotides are a set of polynucleotides that have reproducible accurately measured expression values.

Still another example of normalization is the Z-score mean absolute deviation of log intensity protocol. In this protocol, raw expression intensities are normalized by the Z-score of the log intensity using the equation (log(intensity)-mean logarithm)/standard deviation logarithm. For microarray data, the Z-score mean absolute deviation of log intensity protocol normalizes each bound sample by the mean and mean absolute deviation of the logs of the raw intensities for all of the spots in the sample. The mean log intensity and the mean absolute deviation log intensity are computed for the log of raw intensity of control genes.

Another normalization protocol example is the user normalization polynucleotide set protocol. In this protocol, raw expression intensities are normalized by the sum of the polynucleotides (e.g., sum of the genes) in a user defined polynucleotide set in each sample. This method is useful if a subset of polynucleotides has been determined to have relatively constant expression across a set of samples. Yet another example of a normalization protocol is the calibration polynucleotide set protocol in which each sample is normalized by the sum of calibration polynucleotides. Calibration polynucleotides are polynucleotides that produce reproducible expression values and are accurately measured. Such polynucleotides tend to have substantially the same expression values on each of several different microarrays. The algorithm is the same as user normalization polynucleotide set protocol described above, but the set is predefined as the polynucleotides flagged as calibration DNA.

Yet another normalization protocol example is the ratio median intensity background correction protocol. This protocol is useful in embodiments in which a two-color fluorescence labeling and detection scheme is used, for example. For example, in the case where the two fluors in a two-color fluorescence labeling and detection scheme are Cy3 and Cy5, measurements are normalized by multiplying the ratio (Cy3/Cy5) by medianCy5/medianCy3 intensities. If background correction is enabled, measurements are normalized by multiplying the ratio (Cy3/Cy5) by (medianCy5-medianBkgdCy5)/(medianCy3-medianBkgdCy3) where “medianBkgd” refers to median background levels.

In some embodiments, intensity background correction is used to normalize measurements. The background intensity data from a spot quantification program may be used to correct spot intensity. Background may be specified as a global value or on a per-spot basis in some embodiments. If array images have low background, then intensity background correction may not be necessary.

### Feature Selection

Feature selection is helpful as a preprocessing step for reducing dimensionality, removing irrelevant data, improving learning accuracy and enhancing output comprehensibility in some embodiments. Unlike other dimensionality reduction methods, feature selection preserves the original features after reduction and selection.

Feature selection, also known as variable selection, feature reduction, attribute selection or variable subset selection, is a technique of selecting a subset of relevant features for building robust learning models. When applied to biological situations with regard to polynucleotides, the technique also can be referred to as discriminative polynucleotide selection, which for example detects influential polynucleotides based on DNA microarray experiments. Feature selection also helps acquire a better understanding of data by identifying more important features and their relationship with each other. For example, in the case of yeast cell cycle data, expression values of the polynucleotides correspond to several different time points. The feature selections in the foregoing example can be polynucleotides and time, among others.

Features can be selected in many different ways. Features can be selected manually by a user or an algorithm can be chosen or programmed to aid in selection. One or more feature selections also can be chosen. In certain embodiments, one or more features that correlate to a classification variable are selected.

In certain embodiments, a user may select features that correlate strongest to a classification variable, also known as a maximum-relevance selection. A heuristic algorithm can be used, such as the sequential forward, backward, or floating selections, for example.

In some embodiments, features mutually far away from each other can be selected, while they still have “high” correlation to a classification variable. This approach also is known as minimum-Redundancy-Maximum-Relevance selection (mRMR), which may be more robust than the maximum relevance selection in certain situations.

A correlation approach can be replaced by, or used in conjunction with, a statistical dependency between variables. Mutual information can be used to quantify the dependency. For example, mRMR may be an approximation to maximizing the dependency between joint distribution of the selected features and the classification variable.

Any feature selection of a data set may be chosen. For example, a feature selection may include genes or proteins (e.g., all genes or proteins), a biological category, a chemical category, a biochemical category, a category of genes or proteins, a gene ontology, a protein ontology, co-regulated genes, cell signaling genes, cell cycle genes, proteins pertaining to the foregoing genes, gene variants, protein variants, co-regulated genes, co-regulated proteins, amino acid sequence, nucleotide sequence, protein structure data and the like, and combinations of the foregoing. A feature selection may also be selected or identified by techniques such as gene expression levels, florescence intensity, time of expression, and the like, and combinations of the foregoing. Gene expression levels may be in the form of microarray information with regards to the intensity of a fluorescence signal where higher intensity in relation to a lower intensity signal may signify more gene expression, for example. Co-regulated gene and/or protein data may be in the form of a cell signaling pathway where expression gene vectors can display expression of certain gene promoters with regards to time of expression as well as location of expression, for example. Genes that are regulated with regards to amount of expression and location within specific cell cycles may be investigated, for example.

Search often is a component of feature selection, which can involve search starting point, search direction, and search strategy in some embodiments. A user can measure the goodness of the generated feature subset. Feature selection can be supervised as well as unsupervised learning, depending on the class information availability in data. The algorithms can be categorized under filter and wrapper models, with different emphasis on dimensionality reduction or accuracy enhancement, in some embodiments.

Feature selection has been widely used in supervised learning to improve generalization of uncharacterized data. Many applicable algorithms involve a combinatorial search through the space of all feature subsets. Due to the large size of this search space, that can be exponential in the number of features, heuristics often are employed. Use of heuristics may result in a loss of guarantee regarding optimality of the selected feature subset in certain circumstances. In biological sciences, genetic search and boosting have been used for efficient feature selection. In some embodiments, relevance of a subset of features can be assessed, with or without employing class labels, and sometimes varying the number of clusters.

### Statistical Analysis

A variety of statistical methods can be applied to processes described herein. One or more of statistics, probability theory, data mining, pattern recognition, artificial intelligence, adaptive control, and theoretical computer science can be employed for recognizing complex patterns and making intelligent decisions or connections. For example, machine learning algorithms (e.g., trained machine learning algorithms) and/or other suitable algorithms may be applied to classify data according to learned patterns, for example. Machine learning algorithms include supervised learning, unsupervised learning, semi-supervised learning, reinforcement learning, transduction, learning to learn and pareto-based multi-objective learning.

Two types of algorithms that have been used in biological applications are supervised learning and unsupervised learning, for example. Supervised learning aids in discovering patterns in the data that relate data attributes with a target (class) attribute. These patterns then can be utilized to predict the values of the target attribute in future data instances. Unsupervised learning is used when the data has no target attribute. Unsupervised learning is useful when a user wishes to explore data to identify intrinsic structure within (e.g., to determine how the data is organized).

Non-limiting examples of supervised learning are analytical learning, artificial neural networks, backpropagation, boosting, Bayesian statistics, case-based reasoning, decision tree learning, inductive logic programming, Gaussian process regression, learning automata, minimum message length with decision trees or graphs, naïve Bayes classifiers, nearest neighbor algorithm, probably approximately correct learning (PAC), ripple down rules, symbolic machine learning algorithms, subsymbolic machine learning algorithms, support vector machines, random forests, ensembles of classifiers, ordinal classification, data pre-processing and handling imbalanced datasets.

Examples of unsupervised learning include, but are not limited to, multivariate analysis, artificial neural networks, data clustering, expectation-maximization algorithm, self-organizing map, radial basis function network, generative topographic map, and blind source separation.

Clustering is a statistical technique for identifying similarity groups in data invoked clusters. For example, clustering groups (i) data instances similar to (near) each other in one cluster, and (ii) data instances different from (far away) each other into different clusters. Clustering often is referred to as an unsupervised learning task as no class values denoting an a priori grouping of the data instances normally are provided, where class values often are provided in supervised learning.

Data clustering algorithms can be hierarchical. Hierarchical algorithms often find successive clusters using previously established clusters. These algorithms can be agglomerative (“bottom-up”) or divisive (“top-down”), for example. Agglomerative algorithms often begin with each element as a separate cluster and often merge them into successively larger clusters. Divisive algorithms often begin with the whole set and often proceed to divide it into successively smaller clusters. Partitional algorithms typically determine all clusters at once or in iterations, but also can be used as divisive algorithms in the hierarchical clustering. Density-based clustering algorithms can be devised to discover arbitrary-shaped clusters. In this approach, a cluster often is regarded as a region in which the density of data objects exceeds a threshold. DBSCAN and OPTICS are two typical algorithms of this kind, for example. Two-way clustering, co-clustering or biclustering are clustering methods where not only the objects are clustered but also the features of the objects, i.e., if the data is represented in a data matrix, the rows and columns are clustered simultaneously, for example. Spectral clustering techniques often make use of the spectrum of the data similarity matrix to perform dimensionality reduction for clustering in fewer dimensions. Some clustering algorithms require specification of the number of clusters in the input data set, prior to execution of the algorithm. Barring knowledge of the proper value beforehand, the appropriate value must be determined, a problem for which a number of techniques have been developed.

One step in certain clustering embodiments is to select a distance measure, which will determine how the similarity of two elements is calculated. This selection generally will influence the shape of the clusters, as some elements may be close to one another according to one distance and farther away according to another. For example, in a 2-dimensional space, the distance between the point (x=1, y=0) and the origin (x=0, y=0) is 1 according to usual norms, but the distance between the point (x=1, y=1) and the origin can be 2, √2 or 1 based on the 1-norm, 2-norm or infinity-norm distance, respectively.

Several types of algorithms can be used in partitional clustering, including, but not limited to, k-means clustering, fuzzy c-means clustering, and QT clustering. A k-means algorithm often assigns each point to a cluster for which the center (also referred to as a centroid) is nearest. The center often is the average of all the points in the cluster, that is, its coordinates often are the arithmetic mean for each dimension separately over all the points in the cluster. Examples of clustering algorithms include, but are not limited to, CLARANS, PAM, CLATIN, CLARA, DBSCAN, BIRCH, WaveCluster, CURE, CLIQUE, OPTICS, K-means algorithm, and hierarchical algorithm.

PAM (Partitioning Around Medoids) is an algorithm that can be used to determine k partitions for n objects. After an initial random selection of k-medoids, the technique repeatedly attempts to make a better choice of medoids. All or substantially all of the possible pairs of objects are analyzed, where one object in each pair is considered a medoid, and the other is not. A user may select a PAM algorithm for small data sets, and may select such an algorithm for medium and large data sets.

CLARA (Clustering LARge Applications) and CLARANS (Clustering Large Applications based on RANdomized Search) are other clustering algorithms that can be selected for use in processes described herein. Instead of identifying representative objects for the entire data set, the CLARA algorithm generally draws a sample of the data set, applies PAM on the sample, and finds the medoids of the sample. To arrive at better approximations, CLARA draws multiple samples and yields the best clustering as the output. However, a good clustering based on samples will not necessarily represent a good clustering of the whole data set if the sample is biased. As such, the CLARANS algorithm was developed which generally does not confine itself to any sample at any given time. It draws a sample with some randomness in each step of the search and can be used effectively in processes described herein.

In CLARANS (Raymond T. Ng and Jiawei Han, “Efficient and Effective Clustering Methods for Spatial Data Mining,” Proc. of 20th VLDB Conf., 1994, pp. 144-155) a cluster generally is represented by its medoid, which is the most centrally located data point within the cluster. The clustering process is formalized in terms of searching a graph in which each node is a potential solution. Specifically, a node is a K-partition represented by a set of K medoids, and two nodes are neighbors if they only differ by one medoid. CLARANS starts with a randomly selected node. For the current node, it checks at most the specified “maxneighbor” number of neighbors randomly, and if a better neighbor is found, it moves to the neighbor and continues; otherwise it records the current node as a “local minimum.” CLARANS stops after the specified “numlocal” number of the so-called “local minima” have been found, and returns the best of these.

The solutions that CLARANS finds may be a global minimum or local minimum or both. CLARANS may also search all possible neighbors and set maxneighbor or numlocal to be sufficiently large, such that there is an assurance of finding good partitions. Theoretically, the graph size may be about N^{K /K!,} and the number of neighbors for each node is K(N-K), so as N and K increase, these values grow dramatically. In some embodiments, numlocal is set to 2 and maxneighbor is set to be the larger of 1.25% K(N-K) or 250. With numlocal=2 and maxneighbor=1.25% K(N-K), which part of the graph is searched and how much of the graph is examined may depend upon the data distribution and the choice of starting points for each iteration.

Clustering, feature selection and/or biclustering analyses, alone or in combination, can be applied to polynucleotide expression data (e.g., gene expression data), which often is high-dimensional. Biological knowledge about coexpressed polynucleotides (e.g., genes), for example, can be used in clustering for determining quality-based partitions, in some embodiments.

Grouping of interdependent or correlated polynucleotides (e.g., genes), also termed attribute clustering, can result in attributes within a cluster being more correlated (and interdependent) to each other as compared to those lying in different clusters. Attribute clustering can lead to dimensionality reduction, thereby helping to focus the subsequent search for meaningful partitions within a tightly correlated subset of attributes (instead of the entire attribute space). Optimization of an objective function based on an information measure can be employed to group interdependent genes using mutual correlation, in some embodiments.

Biclustering refers to the simultaneous clustering of polynucleotides (e.g., genes) and conditions in the process of knowledge discovery about local patterns from data. Simultaneous clustering along both dimensions also may be viewed as clustering preceded by dimensionality reduction along columns. The Expectation-Maximization(EM) algorithm can be used for performing mixture-based clustering with feature selection (simultaneous clustering). Two-way sequential clustering of data can be implemented in some embodiments, and can be utilized in conjunction with the biological relevance of polynucleotides (e.g., genes). Extraction of such smaller subspaces results in lower computational requirements, enhanced visualization and faster convergence, particularly, in high-dimensional gene spaces. They can also be modulated according to the interests of a user.

The present technology may employ CLARANS to cluster the attributes, and select the representative medoids (or genes) from each cluster using biological knowledge. Any distance function can be used, including, but not limited to, Euclidean distance, Minkowskii Metric, Manhattan distance, Hamming Distance, Chee-Truiter's distance, maximum norm, Mahalanobis distance, the angle between two vectors or combinations thereof.

In some embodiments, CLARANS is used as a statistical analysis to cluster the gene expression profiles in a reduced gene space, thereby providing direction for extraction of meaningful groups of genes. Given a data set, CLARANS or any other statistical algorithm may be programmed into a computer or a programmable processor or downloaded where a data set can be stored in memory or in a storage location or downloaded via other hardware devices, internet or wireless connection. The user often “performs” or “uses” statistical analysis on the data set by running the data through the algorithm. In other words the data often is processed by the algorithm. Any pertinent algorithm addressed herein may process data automatically without user supervision, in certain embodiments. A computer and/or processor may also modify parameters within an algorithm before and/or after processing the data, with or without user supervision. The data analysis optionally may be repeated one or more times. For example, on the first iteration, CLARANS can cluster a randomly selected set of data and produce a graph of the resulting clustering analysis. In another iteration, CLARANS can draw again another randomly selected set of data to cluster, updating the graph with this new analysis, and so forth. The data analysis optionally may be repeated until all good clusters have been found. In this instance, for example, a pre-defined threshold of what is termed as a “good cluster” has been selected and reached and no more good cluster can be found. The program and/or data may also optionally be modified and reanalyzed one or more times. For example, after finding all pre-defined “good clusters,” the algorithm may be modified to “best fit” the remaining data based on a lower threshold or into “meaningful” clusters as compared with the “good cluster” threshold. A “best-fit” can be (i) defining parameters for generating new clusters based on the lower threshold, and/or (ii) fitting the remaining data with already-clustered data that was based on the “good cluster” threshold. The “remaining data” also may be called outliers, which are discussed further below.

In certain embodiments, a first data set may have a featured selection which aids in analyzing the data with statistical analysis and a second data set and a second featured selection. Or statistical analysis may be performed on the first data set by one or more algorithms based on a feature selection in some embodiments. For example, where the first data set is from a gene expression microarray where the first featured selection is time of gene expression, and the second data set is developmental information of a specific neuronal pathway where the second featured selection is particular genes, the statistical analysis can evaluate the first data set in terms of the neuronal pathway and genes specific to that pathway and their developmental gene expression pattern with regard to time. One or more feature selections may be chosen, one or more data sets may be chosen and data analysis may be evaluated more than once in order to aid in correlating biological meaning from the first data set.

### Outliers

In statistics, an outlier often is an observation numerically distant from the rest of the data. In other words, an outlying observation, or outlier, is one that appears to deviate (e.g., deviate significantly) from other members of the sample in which it occurs. Outliers can occur by chance in any distribution, but they are often indicative of measurement error or that the population has a heavy-tailed distribution, for example. In the former case a user may wish to discard them or use statistics that are robust to outliers. In the latter case outliers may indicate that the distribution has high kurtosis and a user should be cautious in using tools or intuitions that assume a normal distribution. A possible cause of outliers is a mixture of two distributions, which may be two distinct sub-populations, or may indicate “correct trial” versus “measurement error”, which often is modeled by a mixture model. The present technology optionally may identify and include outliers in a suitable manner known in the art, not include outliers or a combination thereof.

In most larger samplings of data, some data points will be further away from the sample mean than what is deemed reasonable. This phenomenon can be due to incidental systematic error or flaws in the theory that generated an assumed family of probability distributions, or it may be that some observations are far from the center of the data, for example. Outlier points can therefore indicate faulty data, erroneous procedures, or areas where a certain theory might not be valid. However, in large samples, a small number of outliers is to be expected and not due to any anomalous condition.

Outliers can have many anomalous causes. A physical apparatus for taking measurements may have suffered a transient malfunction. There may have been an error in data transmission or transcription. Outliers arise due to changes in system behavior, fraudulent behavior, human error, instrument error or simply through natural deviations in populations. A sample may have been contaminated with elements from outside the population being examined. Alternatively, an outlier could be the result of a flaw in the assumed theory, calling for further investigation by the user.

There generally is no rigid mathematical definition of what constitutes an outlier, and determining whether or not an observation is an outlier often is based on user-defined criteria. Even when a normal distribution model is appropriate to the data being analyzed, outliers are expected for large sample sizes and should not automatically be discarded if that is the case. Rejection of outliers is more acceptable in areas of practice where the underlying model of the process being measured and the usual distribution of measurement error are confidently known.

### Statistical Significance

Statistical significance of a result is the probability that the observed relationship (e.g., between variables) or a difference (e.g., between means) in a sample occurred by pure chance (“luck of the draw”), and that in the population from which the sample was drawn, no such relationship or differences exist. Often, statistical significance of a result is informative of the degree to which the result is “true” (in the sense of being representative of the population). The value of a p-value represents a decreasing index of the reliability of a result. The higher the p-value, the less one can believe that the observed relation between variables in the sample is a reliable indicator of the relation between the respective variables in the population. Specifically, the p-value represents the probability of error that is involved in accepting the observed result as valid, that is, as representative of the population. For example, a p-value of 0.05 (i.e. 1/20) indicates that there is a 5% probability that the relation between the variables found in the sample is by chance. In many areas of research, the p-value of 0.05 is customarily treated as an acceptable level. However, any p-value may be chosen. A p-value may be about 0.05 or less (e.g., about 0.05, 0.04, 0.03, 0.02 or 0.01, or less than 0.01 (e.g., about 0.001 or less, about 0.0001 or less, about 0.00001 or less, about 0.000001 or less)). In some fields of science, results that yield p 0.05 are considered statistically significant, with the proviso that this level still involves a probability of error of 5%. Results that are significant at the p≦0.01 level commonly are considered statistically significant, and p≦0.005 or p≦0.001 levels are often called “highly” significant.

Certain tests or measures of significance, include, but are not limited to, comparing means test decision tree, counternull, multiple comparisons, omnibus test, Behrens-Fisher problem, bootstrapping, Fisher's method for combining independent tests of significance, null hypothesis, type I error, type II error, exact test, one-sample Z test, two-sample Z test, one-sample t-test, paired t-test, two-sample pooled t-test having equal variances, two-sample unpooled t-test having unequal variances, one-proportion z-test, two-proportion z-test pooled, two-proportion z-test unpooled, one-sample chi-square test, two-sample F test for equality of variances, confidence interval, credible interval, significance, meta analysis or combination thereof.

Statistical significance of statistical analysis of a first data set based on a second data set can be expressed in any suitable form, including, without limitation, ratio, deviation in ratio, frequency, distribution, probability (e.g., odds ratio, p-value), likelihood, percentage, value over a threshold. Statistical significance may be identified based on one or more calculated variables, including, but not limited to, ratio, distribution, frequency, sensitivity, specificity, standard deviation, coefficient of variation (CV), a threshold, confidence level, score, probability and/or a combination thereof.

### Validation

Validating algorithms often is a process of measuring the effectiveness of an algorithm to achieve a particular outcome or to optimize the algorithm to process data effectively. For a particular algorithm, any suitable validation algorithm may be selected to evaluate it. Use of a validating algorithm is optional and is not required.

For clustering algorithms, the clusters formed may be validated by a validation algorithm. Such cluster validation often evaluates the goodness of a clustering relative to others generated by other clustering algorithms, or by the same algorithms using different parameter values, for example. The number of clusters is set as a user parameter. In many clustering algorithms. There are various methods for interpreting the validity of clusters. For example, certain methods evaluate the distance measure between each object within a cluster or between clusters and/or verify the effective sampling of a data set to determine whether the clusters well-represent the data set.

There are many approaches for identifying optimal number of clusters, best types of clusters, well-represented clusters and the like. Non-limiting examples of such validity indices include the Silhouette Validation method, C index, Goodman-Kruskal index, Isolation index, Jaccard index, Rand index, Class accuracy, Davies-Bouldin index, Xie-Beni index, Dunn separation index, Fukuyama-Sugeno measure, Gath-Geva index, Beta index, Kappa index, Bezdek partion coefficient and the like, or a combination of the foregoing.

### Representation of a Reduced Set

As described above with regard to reducing dimensionality of a data set, where features of a data set that represent the data are identified, such representative features generally are part of a reduced set or a representative reduced set. A reduced set may remove redundant data, irrelevant data or noisy data within a data set yet still provide a true embodiment of the original set, in some embodiments. A reduced set also may be a random sampling of the original data set, which provides a true representation of the original data set in terms of content, in some embodiments. A representative reduced set also may be a transformation of any type of information into a user-defined data set, in some embodiments. For example, a reduced set may be a presentation of representative images from gene microarray expression data. Such representative images may be in the form of a graph, for example. The resulting reduced set, or representation of a reduced set, often is a transformation of original data on which processes described herein operate, reconfigure and sometimes modify.

Any type of representative reduced set media may be used, for example digital representation (e.g. digital data) of, for example, a peptide sequence, a nucleic acid sequence, a gene expression data, gene ontology data, protein expression data, cell signaling data, cell cycle data, protein structure data and the like. A computer or programmable processor may receive a digital or analog (for conversion into digital) representation of an input and/or provide a digitally-encoded representation of a graphical illustration, where the input may be implemented and/or accessed locally or remotely.

A reduced data set representation may include, without limitation, digital data, a graph, a 2D graph, a 3D graph, and 4D graph, a picture, a pictograph, a chart, a bar graph, a pie graph, a diagram, a flow chart, a scatter plot, a map, a histogram, a density chart, a function graph, a circuit diagram, a block diagram, a bubble map, a constellation diagram, a contour diagram, a cartogram, spider chart, Venn diagram, nomogram, and the like, and combination of the foregoing.

A representative reduced set may be generated by any method known in the art. For example, fluorescence intensity of gene microarray data may be quantified or transformed into digital data, this digital data may be analyzed by algorithms and a reduced set produced. The reduced set may be presented or illustrated or transformed into a representative graph, such as a scatter plot, for example.

### Combinations

Suitable methods can be combined with any other suitable methods in combination with each other, repeated one or more times, validated and repeated, modified and performed with modified parameters, repeated until a threshold is reached, modified upon reaching a threshold or modified repeatedly until a threshold has been reached, in certain embodiments. Any suitable methods presented herein may be performed in different combinations until a threshold has been reached, different combinations until an outcome as been reached, different combination until all resources (for example, data sets or algorithms or feature selections) have been depleted. A user may decide to repeat and/or modify and/or change the combination of methods presented herein. Any suitable combination of steps in suitable order may be performed.

### User Interfaces

Provided herein are methods, apparatuses or computer programs where a user may enter, request, query or determine options for using particular information or programs or processes such as data sets, feature selections, statistical analysis algorithms, statistical significance algorithms, statistical algorithms, iterative steps, validation algorithms, and graphical representations, for example. In some embodiments, a data set may be entered by a user as input information or a user may download one or more data sets by any suitable hardware media (i.e. flash drive).

A user also may, for example, place a query to a data set dimensionality reducer which then may acquire a data set via internet access or a programmable processor may be prompted to acquire a suitable data set based on given parameters. A programmable processor also may prompt the user to select one or more data set options selected by the processor based given parameters. A programmable processor also may prompt the user to select one or more data set options selected by the processor based on information found via the internet, other internal or external information, or the like. Similar options may be chosen for selecting the feature selections, statistical analysis algorithms, statistical significance algorithms, statistical algorithms, iterative steps, validation algorithms, and graphical representations of the methods, apparatuses, or computer programs herein.

A processor may be programmed to automatically perform a task described herein that a user: could perform. Accordingly, a processor, or algorithm conducted by such a processor, can require little to no supervision or input from a user (e.g., software may be programmed to implement a function automatically).

Selection of one or more data sets, feature selections, statistical analysis algorithms, statistical significance algorithms, statistical algorithms, iterative steps, validation algorithms, or graphical representations may be chosen based on an outcome, result, sample, specimen, theory, hypothesis, process, option or information that may aid in reducing the dimensionality of one or more data sets.

Acquisition of one or more data sets may be performed by any suitable method or any suitable apparatus or system. Acquisition of one or more feature selections may be performed by any suitable method or any suitable apparatus or system. Acquisition of one or more suitable statistical analysis algorithms may be performed by any convenient method or any convenient apparatus or system. Acquisition of one or more validation algorithms may be performed by any suitable method or any convenient apparatus or system. Acquisition of one or more graphical representations may be performed by any suitable method or any convenient apparatus or system. Acquisition of one or more computer programs used to perform the method presented herein may be performed by any suitable method or any convenient apparatus or system.

### Machines, Software and Data Processing

As used herein, software or software modules refer to computer readable program instructions that, when executed by a processor, perform computer operations. Typically, software is provided on a program product containing program instructions recorded on a computer readable storage medium, including, but not limited to, magnetic media including floppy disks, hard disks, and magnetic tape; and optical media including CD-ROM discs, DVD discs, magneto-optical discs, and other such media on which the program instructions can be recorded.

As used herein, a “logic processing module” refers to a module, optionally embodied in software, that is stored on a program product. This module can acquire data sets, organize data sets and interpret values within the acquired data sets (i.e., genes within a microarray data set). For example, a logic processing module can determine the amount of each nucleotide sequence species based upon the data collected. A logic processing module also may control an instrument and/or a data collection routine based upon results determined. A logic processing module and a data organization module often are integrated and provide feedback to operate data acquisition by the instrument, and hence provide assay-based judging methods provided herein.

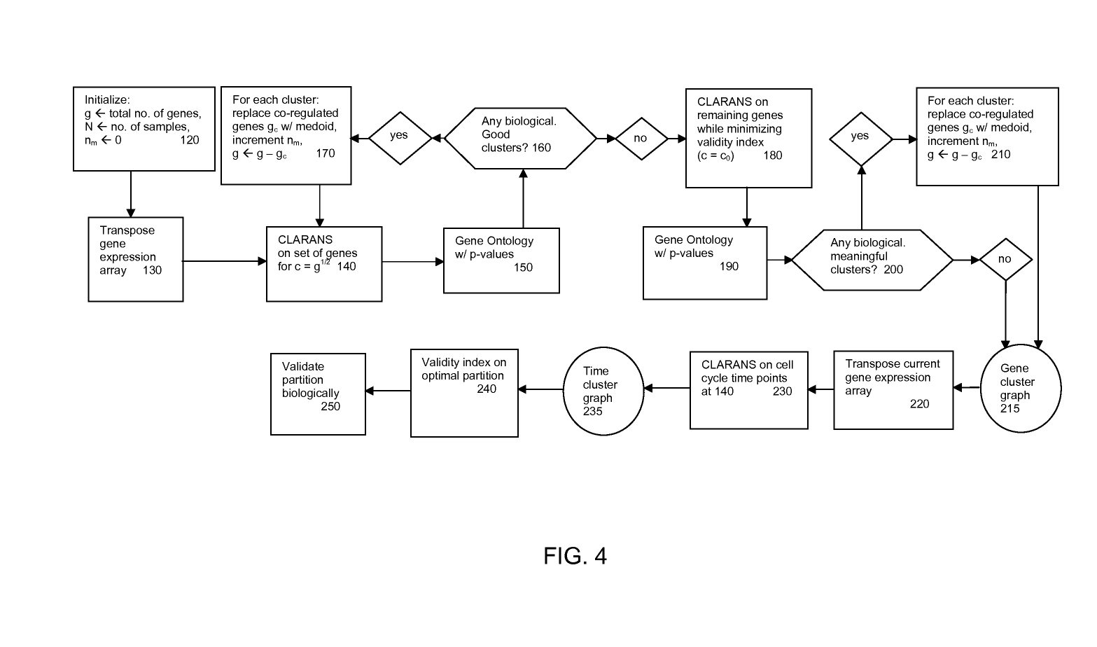

An algorithm in software can be of any suitable type. In mathematics, computer science, and related subjects, an algorithm may be an effective method for solving a problem using a finite sequence of instructions. Algorithms are used for calculation, data processing, and many other fields. Each algorithm can be a list of well-defined instructions for completing a task. Starting from an initial state, the instructions may describe a computation that proceeds through a well-defined series of successive states, eventually terminating in a final ending state. The transition from one state to the next is not necessarily deterministic, for example, some algorithms incorporate randomness. By way of example, without limitation, the algorithm(s) can be search algorithms, sorting algorithms, merge algorithms, numerical algorithms, graph algorithms, string algorithms, modeling algorithms, computational genometric algorithms, combinatorial algorithms, machine learning, cryptography, data compression algorithms and parsing techniques and the like. An algorithm can include one or more algorithms working in combination. An algorithm can be of any suitable complexity class and/or parameterized complexity. An algorithm can be used for calculation or data processing, or used in a deterministic or probabilistic/predictive approach to a method in some embodiments. Any processing of data, such as by use with an algorithm, can be utilized in a computing environment, such as one shown in FIG. 4 for example, by use of a programming language such as C, C++, Java, Pen, Python, Fortran, and the like. The algorithm can be modified to include margin of errors, statistic analysis, statistical significance as well as comparison to other information or data sets (for example in using a neural net or clustering algorithm).

In certain embodiments, several algorithms may be implemented for use in software. These algorithms can be trained with raw data in some embodiments. For each new raw data sample, the trained algorithms produce a representative reduced set. Based on the reduced set of the new raw data samples, the performance of the trained algorithm may be assessed based on sensitivity and specificity. Finally, an algorithm with the highest sensitivity and/or specificity or combination thereof may be identified.

In certain embodiments, simulated (or simulation) data can aid data processing, for example, by training an algorithm or testing an algorithm. Simulated data may for instance involve hypothetical various sampling of different groupings of gene microarray data and the like. Simulated data may be based on what might be expected from a real population or may be skewed to test an algorithm and/or to assign a correct classification based on a simulated data set. Simulated data also is referred to herein as “virtual” data. Simulations can be performed in most instances by a computer program. One possible step in using a simulated data set is to evaluate the confidence of the identified results, i.e. how well the random sampling matches or best represents the original data. A common approach is to calculate the probability value (p-value) which estimates the probability of a random sample having better score than the selected samples. As p-value calculations can be prohibitive in certain circumstances, an empirical model may be assessed, in which it is assumed that at least one sample matches a reference sample (with or without resolved variations). Alternatively, other distributions such as Poisson distribution can be used to describe the probability distribution.

Simulated data often is generated in an in silico process. As used herein, the term “in silico” refers to research and experiments performed using a computer. In silico methods include, but are not limited to, gene expression data, cell cycle data, molecular modeling studies, karyotyping, genetic calculations, biomolecular docking experiments, and virtual representations of molecular structures and/or processes, such as molecular interactions.

In certain embodiments, one or more of ratio, sensitivity, specificity, threshold and/or confidence level are expressed as a percentage by a software algorithm. In some embodiments, the percentage, independently for each variable, is greater than about 90% (e.g., about 90, 91, 92, 93, 94, 95, 96, 97, 98 or 99%, or greater than 99% (e.g., about 99.5%, or greater, about 99.9% or greater, about 99.95% or greater, about 99.99% or greater)). Coefficient of variation (CV) in some embodiments is expressed as a percentage, and sometimes the percentage is about 10% or less (e.g., about 10, 9, 8, 7, 6, 5, 4, 3, 2 or 1%, or less than 1% (e.g., about 0.5% or less, about 0.1% or less, about 0.05% or less, about 0.01% or less)).

In some embodiments, algorithms, software, processors and/or machines, for example, can be utilized to perform a method for reducing dimensionality of a data set including: (a) receiving a first data set and a second data set; (b) choosing a feature selection; (c) performing statistical analysis on the first data set by one or more algorithms based on the feature selection; (d) determining a statistical significance of the statistical analysis based on the second data set; and (e) generating a reduced data set representation based on the statistical significance. In some embodiments, receiving a second data set may be optional. In certain embodiments, determining a statistical significance of the statistical analysis based on the second data set may be optional. In other embodiments, generating a reduced data set representation based on the statistical significance may be optional.

Provided also are methods for reducing dimensionality of a data set performed by a processor including one or more modules. Non-limiting examples of modules include a logic processing module, a data organization module, and a data display organization module. In certain embodiments, a module can perform one or more functions of a logic processing module, a data organization module, and a data display organization module. Certain embodiments include receiving, by a logic processing module, a first data set and a second data set; choosing a feature selection by a data organization module; performing statistical analysis on the first data set by one or more algorithms based on the feature selection by a logic processing module; determining a statistical significance of the statistical analysis based on the second data set by the logic processing module; generating a reduced data set representation based on the statistical significance by the data display organization module in response to being invoked by the logic processing module; and storing the reduced data set representation in a database by either the logic processing module or the data organization module.

By “providing input information” is meant any manner of providing the information, including, for example, computer communication means from a local, or remote site, human data entry, or any other method of transmitting input information. The signal information may be generated in one location and provided to another location.

By “obtaining” or “receiving” a first data set or a second data set or input information is meant receiving, providing and/or accessing the signal information by computer communication means from a local, or remote site, human data entry, or any other method of receiving signal information. The input information may be generated in the same location at which it is received, provided, accessed, or it may be generated in a different location and transmitted to the receiving, provided or accessed location.

Also provided are computer program products, such as, for example, a computer program products including a computer usable medium having a computer readable program code embodied therein, the computer readable program code adapted to be executed to implement a method for generating a reduced data set representation, which includes modules embodied on a computer-readable medium, and where the modules include a logic processing module, a data organization module, and a data display organization module; receiving a first data set and a second data set by the logic processing module; choosing a feature selection by the data organization module in response to being invoked by the logic processing module; performing statistical analysis on the first data set by one or more algorithms based on the feature selection by the logic processing module; determining a statistical significance of the statistical analysis based on the second data set by the logic processing module; generating a reduced data set representation based on the statistical significance by the data display organization module in response to being invoked by the logic processing module; and storing the reduced data set representation in a database. In some embodiments, receiving a second data set may be optional. In certain embodiments, determining a statistical significance of the statistical analysis based on the second data set by the logic processing module may be optional. In other embodiments, generating a reduced data set representation based on the statistical significance may be optional.

Also provided are computer program products, such as, for example, computer program products including a computer usable medium having a computer readable program code embodied therein, the computer readable program code adapted to be executed to implement a method generating a reduced data set representation, which includes modules including a logic processing module, a data organization module, and a data display organization module.

For purposes of these, and similar embodiments, the term “input information” indicates information readable by any electronic media, including, for example, computers that represent data derived using the present methods. For example, “input information” can represent the first and/or second data set, and/or sub sets thereof. Input information, such as in these examples, that may represent physical substances may be transformed into representative data, such as a visual and/or numerical display, that represents other physical substances, such as, for example, gene microarray data or cell cycle data. Identification data may be displayed in any appropriate manner, including, but not limited to, in a computer visual display, by encoding the identification data into computer readable media that may, for example, be transferred to another electronic device (e.g., electronic record), or by creating a hard copy of the display, such as a print out or physical record of information. The information may also be displayed by auditory signal or any other means of information communication. In some embodiments, the input information may be detection data obtained using methods to detect a partial mismatch.

Once the input information or first or second data set is detected, it may be forwarded to the logic-processing module. The logic-processing module may “call” or “identify” the presence or absence of features within the data sets or may use the data organization module for this purpose. The logic processing module may also process data sets by performing algorithms on them. The logic processing module may be programmable and therefore may be updated, changed, deleted, modified and the like. The logic processing module may call upon the data display organization module to generate a reduced data set representation of a data set in any known presentation form. The data display organization module can take any data set in any form (i.e. digital data) and transform or create representations of that data, such as for example in a graph, a 2D graph, a 3D graph, and 4D graph, a picture, a pictograph, a chart, a bar graph, a pie graph, a diagram, a flow chart, a scatter plot, a map, a histogram, a density chart, a function graph, a circuit diagram, a block diagram, a bubble map, a constellation diagram, a contour diagram, a cartogram, spider chart, Venn diagram, nomogram, and combination thereof.

Computer program products include, for example, any electronic storage medium that may be used to provide instructions to a computer, such as, for example, a removable storage device, CD-ROMS, a hard disk installed in hard disk drive, signals, magnetic tape, DVDs, optical disks, flash drives, RAM or floppy disk, and the like.

Systems discussed herein may further include general components of computer systems, such as, for example, network servers, laptop systems, desktop systems, handheld systems, personal digital assistants, computing kiosks, and the like. The computer system may include one or more input means such as a keyboard, touch screen, mouse, voice recognition or other means to allow the user to enter data into the system. The system may further include one or more output means such as a CRT or LCD display screen, speaker, FAX machine, impact printer, inkjet printer, black and white or color laser printer or other means of providing visual, auditory or hardcopy output of information.

Input and output devices may be connected to a central processing unit which may include among other components, a microprocessor for executing program instructions and memory for storing program code and data. In some embodiments the data set dimensionality reducer may be implemented as a single user system located in a single geographical site. In other embodiments methods may be implemented as a multi-user system. In the case of a multi-user implementation, multiple central processing units may be connected by means of a network. The network may be local, encompassing a single department in one portion of a building, an entire building, span multiple buildings, span a region, span an entire country or be worldwide. The network may be private, being owned and controlled by the provider or it may be implemented as an Internet based service where the user accesses a web page to enter and retrieve information.

The various software modules associated with the implementation of the present products and methods can be suitably loaded into the a computer system as desired, or the software code can be stored on a computer-readable medium such as a floppy disk, magnetic tape, or an optical disk, or the like. In an online implementation, a server and web site maintained by an organization can be configured to provide software downloads to remote users. As used herein, “module,” including grammatical variations thereof, means, a self-contained functional unit which is used with a larger system. For example, a software module is a part of a program that performs a particular task. Thus, provided herein is a machine including one or more software modules described herein, where the machine can be, but is not limited to, a computer (e.g., server) having a storage device such as floppy disk, magnetic tape, optical disk, random access memory and/or hard disk drive, for example.

The present methods may be implemented using hardware, software or a combination thereof and may be implemented in a computer system or other processing system. A computer system may include one or more processors in different embodiments, and a processor sometimes is connected to a communication bus. A computer system may include a main memory, sometimes random access memory (RAM), and can also include a secondary memory. The secondary memory can include, for example, a hard disk drive and/or a removable storage drive, representing a floppy disk drive, a magnetic tape drive, an optical disk drive, memory card etc. The removable storage drive reads from and/or writes to a removable storage unit in a well-known manner. A removable storage unit includes, but is not limited to, a floppy disk, magnetic tape, optical disk, etc. which is read by and written to by, for example, a removable storage drive. As will be appreciated, the removable storage unit includes a computer usable storage medium having stored therein computer software and/or data.

In certain embodiments, secondary memory may include other similar approaches for allowing computer programs or other instructions to be loaded into a computer system. Such approaches can include, for example, a removable storage unit and an interface device. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to a computer system.

A computer system also may include a communications interface. A communications interface allows software and data to be transferred between the computer system and external devices. Examples of communications interface can include a modem, a network interface (such as an Ethernet card), a communications port, a PCMCIA slot and card, etc. Software and data transferred via communications interface are in the form of signals, which can be electronic, electromagnetic, optical or other signals capable of being received by communications interface. These signals are provided to communications interface via a channel. This channel carries signals and can be implemented using wire or cable, fiber optics, a phone line, a cellular phone link, an RF link and other communications channels. Thus, in one example, a communications interface may be used to receive signal information to be detected by the signal detection module.

In a related aspect, the signal information may be input by a variety of means, including but not limited to, manual input devices or direct data entry devices (DDEs). For example, manual devices may include, keyboards, concept keyboards, touch sensitive screens, light pens, mouse, tracker balls, joysticks, graphic tablets, scanners, digital cameras, video digitizers and voice recognition devices. DDEs may include, for example, bar code readers, magnetic strip codes, smart cards, magnetic ink character recognition, optical character recognition, optical mark recognition, and turnaround documents. In some embodiments, an output from a gene or chip reader my serve as an input signal. In certain embodiments, a fluorescent signal from a microarray may provide optical input and/or output signal. In some embodiments, the molecular kinetic energy from a reaction may provide an input and/or output signal.

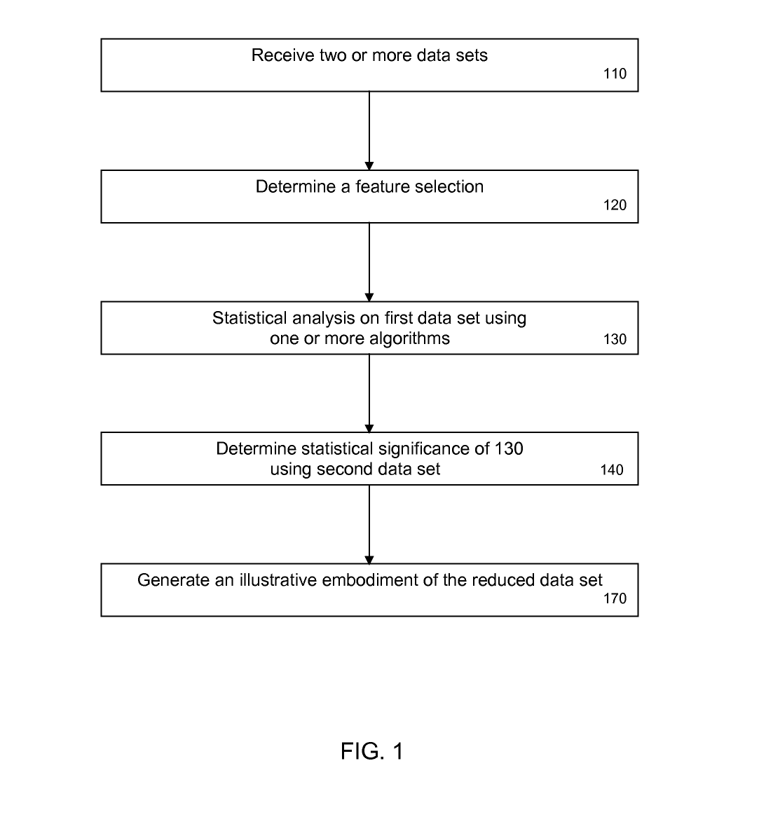

FIG. 1 shows an operational flow representing an illustrative embodiment of operations related to reducing dimensionality of a data set based on one or more feature selections. In FIG. 1, and in the following figures that include various illustrative embodiments of operational flows, discussion and explanation may be provided with respect to apparatus and methods described herein, and/or with respect to other examples and contexts. The operational flows may also be executed in a variety of other contexts and environments, and or in modified versions of those described herein. In addition, although some of the operational flows are presented in sequence, the various operations may be performed in various repetitions, concurrently, and/or in other orders than those that are illustrated.

The operational flow of FIG. 1 may begin with receiving two or more data sets 110. Such data sets, for example, may be entered by the user as input information or a user may download one or more data sets by any hardware media (i.e. flash drive) or a user may place a query to a processor which then may acquire a data set via internet access or a programmable processor may be prompted to acquire a data set. Once two or more data sets have been received, a feature selection is determined 120. The selection, for example, may be chosen by a user, a data organization module, or selection can be performed by processing the data set by an algorithm, statistics, modeling, a simulation in silico or any combination thereof. For example, if gene microarray data is the entered data set, then a chosen feature selection may be the genes within the microarray. Statistical analysis on the first data set is performed using one or more algorithms 130. For example, one or more algorithms can process the data set based on the feature selection. The algorithms may work independently of one another, in conjunction with each other or sequentially one after another. The statistical significance of the first data set in 130 is determined by using the second data set 140. This aids in determining whether the algorithm(s) of 130 may need to be modified, whether the first data set contains similar or dissimilar information as compared to the second data set or some comparison thereof, for example. Or whether a new data set or algorithm(s) may need to be received or implemented. An illustrative embodiment of the reduced data set is then generated 170. The reduced data set being generated from the original first data set.

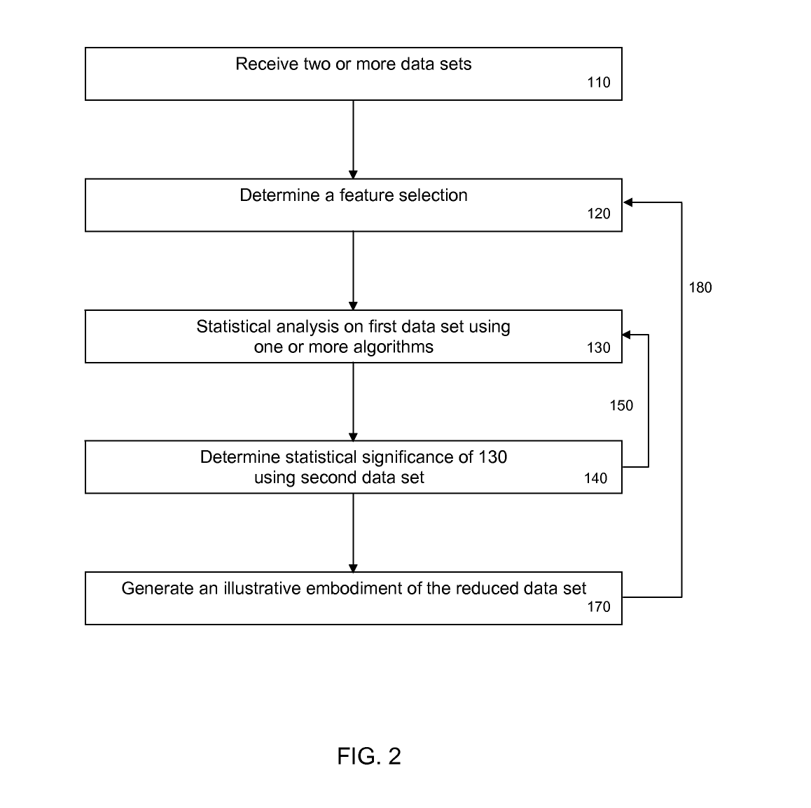

FIG. 2 shows an operational flow representing illustrative embodiments of operations related to reducing dimensionality of a data set based on one or more feature selections. Similar to FIG. 1, the operational flow of FIG. 2 generally outlines a method described herein, where two or more data sets are received 110, a feature selection is determined 120, statistical analysis on the first data set is performed using one or more algorithms 130, the statistical significance of 130 is determined using the second data set 140, and an illustrative embodiment of the reduced data set is generated 170. An optional iterative operation 150 may occur after 140 where statistical analysis on the first data set using one or more algorithms 130 is repeated. Such an iterative process 150 may optionally occur one or more times. Such iterative process 150 may also occur after the first data set is modified by the first and/or subsequent iteration(s) or after the one or more algorithms are modified based on the statistical significance 130. Such iterative process 150 may also occur after the first data set is replaced and/or the one or more algorithms are replaced. An optional iterative operation 180 may occur after 170 where another feature selection is determined 120. Such an iterative process 180 may optionally occur one or more times. After the first and subsequent iterations, any of the following 120, 130, 140, and 170 may occur after replacement, modification and/or comparison of the first data set, the second data set, one or more algorithms, statistical significance, the feature selection(s), the reduced data set or the illustrative embodiment.

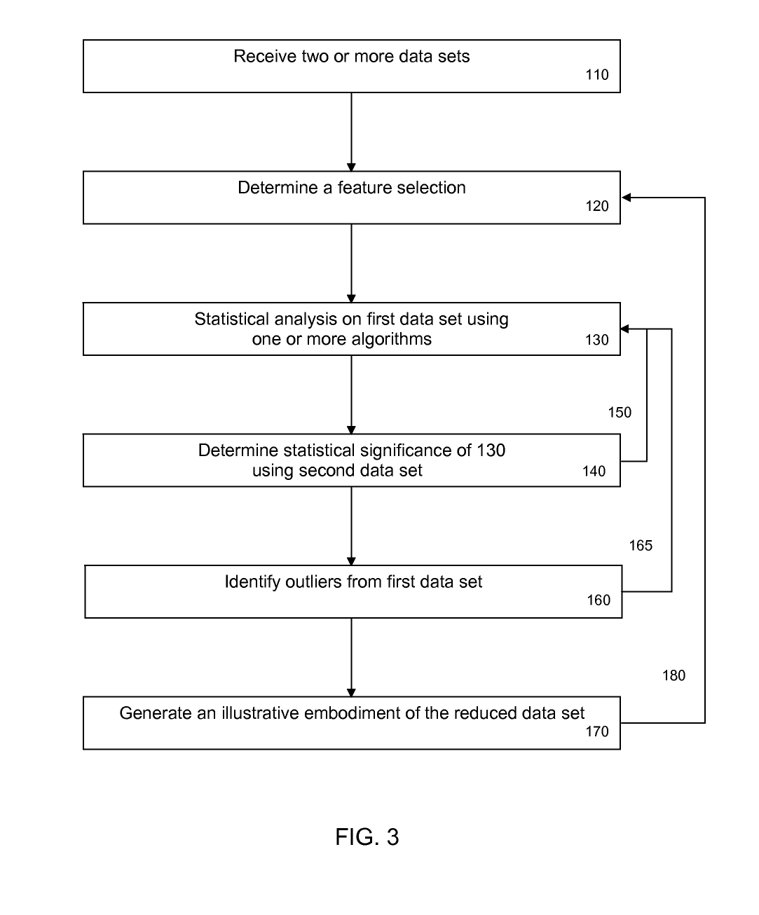

FIG. 3 shows an operational flow representing illustrative embodiments of operations related to reducing dimensionality of a data set based on one or more feature selections. Similar to FIG. 2, the operational flow of FIG. 3 generally outlines a method described herein, where two or more data sets are received 110, a feature selection is determined 120, statistical analysis on the first data set is performed using one or more algorithms 130, the statistical significance of 130 is determined using the second data set 140, outliers from the first data set are identified 160 and an illustrative embodiment of the reduced data set is generated 170. An optional iterative operation 150 may occur after 140 where statistical analysis on the first data set using one or more algorithms 130 is repeated. Such an iterative process 150 may optionally occur one or more times. Such iterative processing 150 may also occur after the first data set is modified by the first and/or subsequent iteration(s) or after the one or more algorithms are modified based on the statistical significance 130. Such iterative process 150 may also occur after the first data set is replaced and/or the one or more algorithms are replaced. An optional iterative operation 180 may occur after 170 where another feature selection is determined 120. Such an iterative process 180 may optionally occur one or more times. After the first and subsequent iterations, any of the following 120, 130, 140, 160, and 170 may occur after replacement, modification and/or comparison of the first data set, the second data set, one or more algorithms, statistical significance, the feature selection(s), the outliers, the reduced data set or the illustrative embodiment. An optional iterative operation 165 may occur after 160 where statistical analysis on the first data set using one or more algorithms 130 is repeated. Such an iterative process 165 may optionally occur one or more times. Such iterative processing 165 may also occur after the first data set is modified by the first and/or subsequent iteration(s) or after the one or more algorithms are modified based on the statistical significance 130. Such iterative process 165 may also occur after the first data set is replaced and/or the one or more algorithms are replaced.

A non-limiting example of how a process in FIG. 3 can occur is shown in FIG. 4. The operational flow of FIG. 4 generally outlines a method described herein where a first data set 120 of gene expression array is initialized with g=total number of genes and N=number of samples where nₘ=0; the gene expression array is transposed 130 and a feature selection is chosen as genes within the array; the algorithm CLARANS clusters the first data set based on genes within the array 140; the statistical significance (p-value) is performed on 140 using a second data set of gene onotology to see how the genes are being clustered by CLARANS 150; meaningful clusters are then determined 160; if meaningful clusters are being determined by the p-value (yes) then for each cluster replace co-regulated genes g_{c} with medoid and increment nₘ such that g=g−g_{c} 170; then repeat 140, 150 and 160 till no other good clusters are found in the first data set (no); CLARANS clusters remaining genes (outliers) creating “meaningful” clusters or less than “good” clusters while minimizing validity index (c=cₙ) 180; the statistical significance (p-value) is performed on 180 using the second data set of gene onotology to see how the outlier genes are being clustered by CLARANS 190; if good clusters are being determined by the p-value (yes) then for each cluster replace co-regulated genes g_{c} with medoid and increment nₘ such that g=g−g_{c} 210; if no meaningful clusters (no) then proceed; a reduced set of clustered genes from the first data set is produced as a graph 215; and the gene expression array is transposed 220. From here 220 iterates back to 140 in the operational flow where CLARANS clusters based on the second feature selection of cell cycle time points, where 140 through 210 are repeated and a reduced set of clustered time points for cell cycle from the first data set is produced as a graph 235; cluster validity index to evaluate optimal partition is performed 240; and biologically validate the generated segments in terms of original cell-cycle data 250. With CLARANS clustering the first data set and producing good clusters at 160, a threshold may be set to determine what is a good cluster. Where CLARANS clusters the remaining genes in the first data set at 180, or the outliers, into “meaningful” clusters or clusters that are less than “good” clusters, another lower threshold may be set to determine a meaningful cluster. The graph produced at 215, based on the first feature selection, and the graph produced at 235, based on the second feature selection, may be the same graph updated, modified or combined. The graphs 215 and 235 may also be separate.

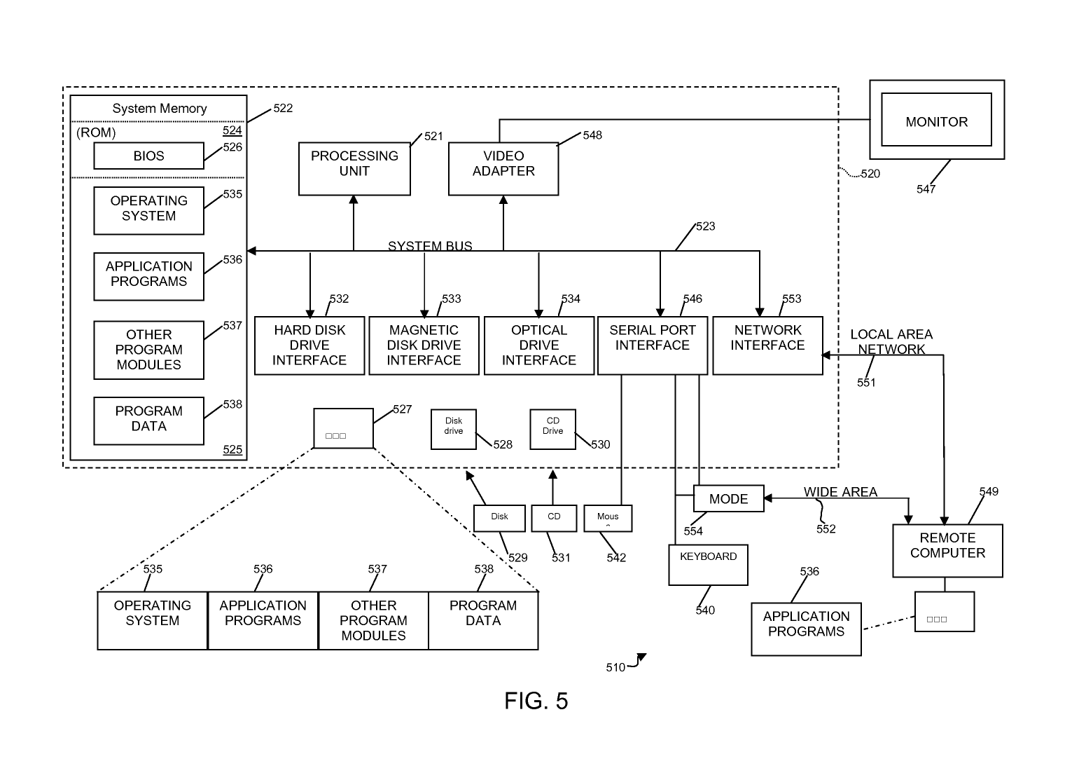

FIG. 5 illustrates a non-limiting example of a computing environment 510 in which various systems, methods, algorithms, and data structures described herein may be implemented. The computing environment 510 is only one example of a suitable computing environment and is not intended to suggest any limitation as to the scope of use or functionality of the systems, methods, and data structures described herein. Neither should computing environment 510 be interpreted as having any dependency or requirement relating to any one or combination of components illustrated in computing environment 510. A subset of systems, methods, and data structures shown in FIG. 5 can be utilized in certain embodiments.

Systems, methods, and data structures described herein are operational with numerous other general purpose or special purpose computing system environments or configurations. Examples of known computing systems, environments, and/or configurations that may be suitable include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The operating environment 510 of FIG. 5 includes a general purpose computing device in the form of a computer 520, including a processing unit 521, a system memory 522, and a system bus 523 that operatively couples various system components including the system memory 522 to the processing unit 521. There may be only one or there may be more than one processing unit 521, such that the processor of computer 520 includes a single central-processing unit (CPU), or a plurality of processing units, commonly referred to as a parallel processing environment. The computer 520 may be a conventional computer, a distributed computer, or any other type of computer.

The system bus 523 may be any of several types of bus structures including a memory bus or memory controller, a peripheral bus, and a local bus using any of a variety of bus architectures. The system memory may also be referred to as simply the memory, and includes read only memory (ROM) 524 and random access memory (RAM). A basic input/output system (BIOS) 526, containing the basic routines that help to transfer information between elements within the computer 520, such as during start-up, is stored in ROM 524. The computer 520 may further include a hard disk drive interface 527 for reading from and writing to a hard disk, not shown, a magnetic disk drive 528 for reading from or writing to a removable magnetic disk 529, and an optical disk drive 530 for reading from or writing to a removable optical disk 531 such as a CD ROM or other optical media.

The hard disk drive 527, magnetic disk drive 528, and optical disk drive 530 are connected to the system bus 523 by a hard disk drive interface 532, a magnetic disk drive interface 533, and an optical disk drive interface 534, respectively. The drives and their associated computer-readable media provide nonvolatile storage of computer-readable instructions, data structures, program modules and other data for the computer 520. Any type of computer-readable media that can store data that is accessible by a computer, such as magnetic cassettes, flash memory cards, digital video disks, Bernoulli cartridges, random access memories (RAMs), read only memories (ROMs), and the like, may be used in the operating environment.

A number of program modules may be stored on the hard disk, magnetic disk 529, optical disk 531, ROM 524, or RAM, including an operating system 535, one or more application programs 536, other program modules 537, and program data 538. A user may enter commands and information into the personal computer 520 through input devices such as a keyboard 540 and pointing device 542. Other input devices (not shown) may include a microphone, joystick, game pad, satellite dish, scanner, or the like. These and other input devices are often connected to the processing unit 521 through a serial port interface 546 that is coupled to the system bus, but may be connected by other interfaces, such as a parallel port, game port, or a universal serial bus (USB). A monitor 547 or other type of display device is also connected to the system bus 523 via an interface, such as a video adapter 548. In addition to the monitor, computers typically include other peripheral output devices (not shown), such as speakers and printers.

The computer 520 may operate in a networked environment using logical connections to one or more remote computers, such as remote computer 549. These logical connections may be achieved by a communication device coupled to or a part of the computer 520, or in other manners. The remote computer 549 may be another computer, a server, a router, a network PC, a client, a peer device or other common network node, and typically includes many or all of the elements described above relative to the computer 520, although only a memory storage device 550 has been illustrated in FIG. 5. The logical connections depicted in FIG. 5 include a local-area network (LAN) 551 and a wide-area network (WAN) 552. Such networking environments are commonplace in office networks, enterprise-wide computer networks, intranets and the Internet, which all are types of networks.

When used in a LAN-networking environment, the computer 520 is connected to the local network 551 through a network interface or adapter 553, which is one type of communications device. When used in a WAN-networking environment, the computer 520 often includes a modem 554, a type of communications device, or any other type of communications device for establishing communications over the wide area network 552. The modem 554, which may be internal or external, is connected to the system bus 523 via the serial port interface 546. In a networked environment, program modules depicted relative to the personal computer 520, or portions thereof, may be stored in the remote memory storage device. It is appreciated that the network connections shown are non-limiting examples and other communications devices for establishing a communications link between computers may be used.

### EXAMPLES

The examples set forth below illustrate certain embodiments and do not limit the disclosed technology.

### Example 1

### Clustering

A large data set can be represented as a reduced set of clusters using a CLARANS algorithm. Large datasets require the application of scalable algorithms. CLARANS draws a sample of the large data, with some randomness, at each stage of the search. Each cluster is represented by its medoid. Multiple scans of the database are required by the algorithm. Here the clustering process searches through a graph G, where node v^{q} is represented by a set of c medoids (or centroids) {m₁^{q},m_{c}^{q}}. Two nodes are termed as neighbors if they differ by only one medoid. More formally, two nodes v¹={m₁¹,m_{c}¹} and v²={m₁², m_{c}²} are termed neighbors if and only if the cardinality of the intersection of v¹ and v² is given as card(v¹∩v²)=c−1. Hence each node in the graph has c*(N−c) neighbors. For each node v^{q} a cost function may be assigned by Equation 1:

$${J}_{c}^{q} = {\sum }_{{x}_{j} ∈ {U}_{i}} {\sum }_{k = 0}^{c} {d}_{ji}^{q} \qquad Equation 1$$

where dⱼᵢ^{q} denotes the dissimilarity measure of the jth object ^{x}j from the ith cluster medoid mᵢ^{q}in the qth node. The aim is to determine that set of c medoids {m₁⁰,m_{c}⁰} at node v^{D}, for which the corresponding cost is the minimum as compared to all other nodes in the tree. The dissimilarity measure used in this example is the Euclidean distance of jth object from ith medoid at qth node. Any other dissimilarity measure can be used. Examples of other measures include the Minkowski Metric, Manhattan distance, Hamming Distance, Chee-Truiter's distance, maximum norm, Mahalanobis distance, the angle between two vectors or combination thereof.

The algorithm may consider two parameters: num local , representing the number of iterations (or runs) for the algorithm, and maxneighbor, the number of adjacent nodes (set of medoids) in the graph G that need to be searched up to convergence. These parameters are provided as input at the beginning. The main steps, thereafter, are outlined as follows:

1) Set iteration counter i←1, and set the minimum cost to an arbitrarily large value. A pointer bestnode refers to the solution set.
2) Start randomly from any node v^{current} in graph G, including of c medoids. Compute cost J_{c}^{current} by equation. (1).
3) Set node counter j←1.
4) Select randomly a neighbor vⁱ of node v^{current}. Compute the cost J_{c}^{j} by equation. (1).
5) If the criterion function improves as J_{c}^{j}<J_{c}^{current}
Then set the current node to be this neighbor node by current ←j, and go to Step 3 to search among the neighbors of the new v^{current}
Else increment j by one.
   6) If j≦maxneighbor
Then go to Step 4 to search among the remaining allowed neighbors of v^{current}
Else calculate the average distance of patterns from medoids for this node; this requires one scan of the database.
   7) If J_{c}^{current}<mincost

Then set mincost←J_{c}^{current} and choose as a solution this set of medoids given by bestnode←current.

8) Increment the number of iterations i by 1.
If i>numlocal
Then output bestnode as the solution set of medoids and halt
Else go to Step 2 for the next iteration.
   The variable maxneighbor can be computed according to Equation 2:

maxneighbor=p % of {c*(N−c)} Equation 2

with p being provided as input by the user. Typically, 1.25≦p≦1.5.

### Example 2

### Clustering Validity Indices

To evaluate the goodness of clustering by any clustering algorithm, validity indices can be used on the clusters. Any validation indices may be used. Below demonstrates two such indices.

One clustering algorithm described here is partitive, requiring pre-specification of the number of clusters. The result is dependent on the choice of c (centroids). There exist validity indices to evaluate the goodness of clustering, corresponding to a given value of c. Two of the commonly used measures include the Davies-Bouldin (DB) and the Xie-Beni (XB) indices. The DB index is a function of the ratio of sum of within-cluster distance to between-cluster separation. The index is expressed according to Equation 3:

$$DB = \frac{1}{c} {\sum }_{i = 1}^{c} {max}_{j \neq i} \frac{diam ( {U}_{i} ) + diam ( {U}_{j} )}{{d}^{′} ( {U}_{i} , {U}_{j} )} \qquad Equation 3$$

where the diameter of cluster Uᵢ is

$$diam ( {U}_{i} ) = \frac{1}{{\vert U \vert}_{i}} {\sum }_{{x}_{j} ∈ {U}_{i}} {‖ {x}_{j} - {m}_{i} ‖}^{2} .$$

Here |Uᵢ| is the cardinality of cluster Uᵢ and ∥ ∥ is the Euclidean norm. The inter-cluster distance between cluster pair Uᵢ, Uⱼ is expressed as d¹ (Uᵢ, Uⱼ)=∥mᵢ−mⱼ∥². Since the objective is to obtain clusters with lower intra-cluster distance and higher inter-cluster separation, therefore DB is minimized when searching for the optimal number of clusters c_{D}.

The XB index is defined according to Equation 4:

$$XB = \frac{{\sum }_{j = 1}^{N} {\sum }_{i = 1}^{c} {μ}_{ij}^{{m}^{′}} {d}_{ji}}{N * {min}_{i , j} {{d}^{′} ( {U}_{i} , {U}_{j} )}^{2}} \qquad Equation 4$$

where μᵢⱼ is the membership of pattern ^{x}j to cluster Uᵢ. Minimization of XB is indicative of better clustering. Note that for crisp clustering the membership component μᵢⱼ boils down to zero or one. In all the experiments m^{l}=2 was selected.

### Example 3

### Feature Selection

Choosing a feature selection is described below. Feature selection plays an important role in data selection and preparation for subsequent analysis. It reduces the dimensionality of a feature space, and removes redundant, irrelevant, or noisy data. It enhances the immediate effects for any application by speeding up subsequent mining algorithms, improving data quality and thereby performance of such algorithms, and increasing the comprehensibility of their output.

A minimum subset of M features is selected from an original set of N features (M≦N), so that the feature space is optimally reduced according to an evaluation criterion. Finding the best feature subset is often intractable or NP-hard. Feature selection typically involves (i) subset generation, (ii) subset evaluation, (iii) stopping criterion, and (iv) validation.

Attribute clustering is employed, in terms of CLARANS, for feature selection. This results in dimensionality reduction, with particular emphasis on high-dimensional gene expression data, thereby helping one to focus the search for meaningful partitions within a reduced attribute space. While most clustering algorithms require user-specified input parameters, it is often difficult for biologists to manually determine suitable values for these. The use of clustering validity indices for an automated determination of optimal clustering may be performed.

Biological knowledge is incorporated, in terms of gene ontology, to automatically extract the biologically relevant cluster prototypes.

### Example 4

### Gene Ontology

The biological relevance of the gene clusters for the yeast cell-cycle data is determined in terms of the statistically significant Gene Ontology (GO) annotation database . Here genes are assigned to three structured, controlled vocabularies (ontologies) that describe gene products in terms of associated biological processes, components and molecular functions in a species-independent manner. Such incorporation of knowledge enables the selection of biologically meaningful groups, including of biologically similar genes.

The degree of enrichment i.e., p-values has been measured using a cumulative hypergeometric distribution, which involves the probability of observing the number of genes from a particular GO category (i.e., function, process, component) within each feature (or gene) subset. The probability p for finding at least k genes, from a particular category within a cluster of size n, is expressed as Equation 5:

$$p = 1 - {\sum }_{i = 0}^{k - 1} \frac{( \begin{matrix}f \\ i\end{matrix} ) ( \begin{matrix}g - f \\ n - i\end{matrix} )}{( \begin{matrix}g \\ i\end{matrix} )} \qquad Equation 5$$

where f is the total number of genes within a category and g is the total number of genes within the genome. The p-values are calculated for each functional category in each cluster. Statistical significance is evaluated for the genes in each of these partitions by computing p-values, that signify how well they match with the different GO categories. Note that a smaller p-value, close to zero, is indicative of a better match.

### Example 5

### Generating a Reduced Data Set Using Microarray Data

The combination of algorithms, data sets and feature selection described in the foregoing examples can be used to generate a representative reduced data set. This algorithm is a two-way clustering algorithm on gene microarray data as the first data set and using gene ontology data as the second data set. CLARANS is the algorithm used to cluster the data set and the feature selections are genes and expression time.

First clustering for feature selection is performed, with c=\sqrt{g}. The prototype (medoid) of each biologically “good” gene cluster (measured in terms of GO) is selected as the representative gene (feature) for that cluster, and the remaining genes in that cluster are eliminated. Thereafter the remaining set of genes (in the “not-so-good” clusters) are again partitioned with CLARANS, for c=c_{D} which minimizes the validity indices of equations 3 and 4 from Example 2 above. Finally the goodness of the generated partitions are biologically evaluated in terms of GO, and the representative genes selected.

Upon completion of gene selection, the gene expression dataset is transposed and re-clustered on the conditions in the reduced gene space. The cluster validity index is used to evaluate the generated partitions. The time-phase distribution of the cell-cycle data is studied to biologically justify the generated partitions. Such two-way sequential clustering leads to dimensionality reduction, followed by partitioning into biological relevant subspaces.

The steps of the algorithm are outlined below.
1. Initialize g←no. of genes, N←no. of samples
   Initialize no. of medoids nₘ←0.
2. Transpose the gene expression array.
3. Cluster set of genes using CLARANS for c=\sqrt{g}.
4. Use gene ontology to detect co-regulated genes in terms of process, component and function related p-values<=e^{-0s}.
5. If any biologically meaningful cluster is detected
   Then perform Step 6 for each such cluster
   Else go to Step 8.
6. Replace sets of co-regulated genes g_{c} by its medoid, increment nₘ, and decrement g←g−g_{c}.
7. Repeat Steps 3-6 until no more good clusters can be found.
8. Cluster the remaining set of genes g with CLARANS while minimizing validity index.

Test p-value and compress each such biologically meaningful cluster by its medoid, such that g←g−g_{c} and nₘ←nₘ+1.
9. Re-transpose the gene expression array to cluster the cell-cycle in the reduced space of g genes corresponding to nₙ, medoids.
10. Use cluster validity index to evaluate optimal partition.
11. Biologically validate the generated segments in terms of original cell-cycle data.

The grouping of genes, based on gene ontology analysis, helps to capture different aspects of gene association patterns in terms of associated biological processes, components and molecular functions. The mean of a cluster (which need not coincide with any gene) is replaced by the medoid (or most representative gene), and deemed significant in terms of ontology study. The set of medoids, selected from the partitions, contain useful information for subsequent processing of the profiles. The smaller number of the significant genes leads to a reduction of the search space as well as enhancement of performance for clustering.

### Example 6

### Analysis of Results

The proposed two-way clustering algorithm on microarray data was implemented on two gene expression datasets for Yeast, viz. (i) Set 1: Cho et al. and (ii) Set 2: Eisen et al. (R. J. Cho, M. J. Campbell, L. A. Winzeler, L. Steinmetz, A. Conway, L. Wodicka, T. G. Wolfsberg, A. E. Gabrielian, D. Landsman, D. J. Lockhart, and R. W. Davis. A genome-wide transcriptional analysis of the mitotic cell cycle. Molecular Cell, 2: 65-73, 1998. M. B. Eisen, P. T. Spellman, P. O. Brown, and D. Botstein, “Cluster analysis and display of genome-wide expression patterns,” Proceedings of National Academy of Sciences USA, vol. 95, pp. 14 863-14 868, 1998). For Set 1 the yeast data is a collection of 2884 genes (attributes) under 17 conditions (time points), having 34 null entries with -1 indicating the missing values. All entries are integers lying in the range of 0 to 600. The missing values are replaced by random number between 0 to 800.

Table 1 presents a summary of the two-stage clustering process for the two datasets. It is observed that the reduced gene set, upon attribute clustering, results in a lower clustering validity index DB for both cases. The optimal number of partitions are indicated in column 2 of the table.

TABLE 1
Comparative study on the two Yeast data sets

| | # Clusters for | | | Reduced | |
|---|---|---|---|---|---|
| | minimum | Original gene space | | gene space | |
| Data Set | index | # genes | DB | # genes | DB |
| Cho et al. | 2 | 2884 | 0.07 | 15 | 0.05 |
| (Set 1) | | | | | |
| Eisen et al. | 5 | 6221 | 18.06 | 41 | 0.08 |
| (Set 2) | | | | | |

TABLE 2
Analysis of Cell Cycle for Set 1

| | Time (× | |
|---|---|---|
| Cell Cycle | 10 min) | Phase |
| 1 (1-9) | 1-3 | G1 |
| | 3-5 | S |
| | 5-7 | G2 |
| | 7-9 | M |
| | 9-11 | G1 |
| 2 (9-17) | 11-13 | S |
| | 13-15 | G2 |
| | 15-17 | M |

A. Set 1

The ORF's (open reading frame) of the genes (or medoids) corresponding to the attribute clusters selected (with cardinality marked in bold and underlined) in Table 3, by Steps 3-6 of the algorithm, are as follows.

Iteration 1: YDL215C, YDR394W, YGR122W, YDR385W, YKL190W, YGRO92W, YEL074W, YER018c, YFLO30W, YPR131c, YIL087C,

Iteration 2: YLL054C, YML066C, YOR358W,

followed by YHR012W, as generated by Step 8 of the algorithm.

TABLE 3
First pass clustering for dimensionality reduction, based on gene ontology
study, on Yeast data (Set 1)

| | | | No. of |
|---|---|---|---|
| | | | Com- |
| | | | pressed |
| | | | clusters |
| Iteration | No. of clusters | Genes in each cluster | nₘ |
| | | 62, 40, 84, 71, 27, 14, 47, 55, 32, | |
| | | 49, 87, 32, 15, 25, 80, 79, 45, 109, | |
| | | 71, 92, | |
| 1 | √2879 = 54 | 50, 81, 55, 56, 65, 35, 17, | 11 |
| | | 74, 64, 22, 37, 42, 49, 60, 62, 84, 30, | |
| | | 39, 78, 86, | |
| | | 39, 45, 121, 56, 46, 44, 54, | |
| | | 32, 60, 32, 24, 27, 43, 22 | |
| | | 49, 24, 27, 47, 45, 72, | |
| | | 36, 17, 58, 29, 29, 35, 29, 79, 38, | |
| | | 62, 30, 30, 43, 65, | |
| 2 | √2879 − 447 = | 69, 43, 12, 45, 80, 51, 82, 41, 31, 98, | 3 |
| | 49 | 78, 27, 25, 29, 67, 74, 30, 59, 42, 56, | |
| | | 30, 69, 44, 83, 83, 91, 55, 44, 50 | |
| | | 61, 50, 27, 17, 47, 53, 53, 63, 33, 103, | |
| | | 64, 72, 24, 40, 43, 94, 24, 40, 50, 27, | |
| 3 | √2432 − 95 = | 61, 63, 29, 56, 43, 36, 29, 125, | NIL |
| | 48 | 26, 29, 19, 42, 27, 36, 59, 37, 63, 49, | |
| | | 71, 34, 19, 73, 20, 84, 43, 59, 38, 82 | |

TABLE 4
Second pass clustering using validity index on Set 1

| | Davies- | Time points |
|---|---|---|
| No. of | Bouldin | in each |
| clusters | Index | cluster |
| 2 | 0.05 | 1-8, 9-17 |
| 3 | 0.06 | 1, 2-8, 9, |
| | | 10-12, 13, |
| | | 14-17 |
| 4 | 0.07 | 1, 2-8, 9, 10- |
| | | 11, 12-13, |
| | | 14-17 |
| 5 | 0.08 | 1-2, 3-5, 6- |
| | | 8, 9, 10-11, |
| | | 12-133, 14-17 |
| 6 | 0.08 | 1-2, 3-5, 6- |
| | | 8, 9, 12-15, |
| | | {10-11, 16-17} |
| 7 | 0.08 | 1-2, 3-5, 6- |
| | | 8, 9, 10, 12- |
| | | 13, {11, 14-17} |
| 8 | 0.08 | 1, 2, 3-5, 6- |
| | | 8, 9, 10, 11- |
| | | 12, 13, 14- |
| | | 15, 16-17 |

These genes are then selected as the reduced attribute set for the second stage of clustering in Table 4. It is observed that the partitioning corresponding to two clusters (time points 1-8, 9-16) is biologically meaningful as evident from the cell-cycle data of Table 2. Note that even though the partitioning in the original gene space (without attribute clustering) resulted in a minimum value of DB for two clusters in Table 6, yet the corresponding time points did not corroborate with those of the cell-cycle data.

TABLE 5
Comparative study on clustering validity index in Cho data (Set 1)

| | Reduced | Original |
|---|---|---|
| No. of | feature | feature |
| clusters | space | space |
| 2 | 0.05 | 0.07 |
| 3 | 0.06 | 0.09 |
| 4 | 0.07 | 0.19 |
| 5 | 0.08 | 0.23 |
| 6 | 0.08 | 0.55 |
| 7 | 0.08 | 0.63 |
| 8 | 0.08 | 0.36 |

TABLE 6
Comparative study on clustering time points in Cho data (Set 1)

| | Reduced | |
|---|---|---|
| | feature | Original feature |
| Cluster no. | space | space |
| 2 | 1-8, 9-17 | {1-2, 4-9, 12- |
| | | 13, 16-17}, {3, 10- |
| | | 11, 14-15} |
| 7 | 1-2, 3-5, 6- | |
| | 8, 9, 10, 12- | 6, 9, 16, {2, 7, 12},{4- |
| | 13, {11, 14- | 5, 17}, {1, 8}, {3, 10- |
| | 17} | 11, 14-15} |

TABLE 7
Analysis of Cell-Cycle for Set 2 over 60 time periods

| Time | Phase |
|---|---|
| 1-18 | Cell-cycle |
| | Alpha- |
| | Factor1 |
| 19-43 | Cell-cycle |
| | cdc15 |
| 44-57 | Cell-cycle |
| | Elutrition |
| 58-60 | Cell-cycle |
| | CLN3 |
| | induction |

B) Set 2

The ORF's of the genes corresponding to the clusters selected (with cardinality marked in bold and underlined) in Table 8, by Steps 3-6 of the algorithm, are as follows.

Iteration 1: YNL233W, YBR181c, YJL010C, YHR198c, YLR229c, YLL045C, YBR056W, YEL027W, YCL017C, YJL180C, YBL075C, YCL019W, YHR196W, YER124c, YGL021W, YHL047C, YHR074W, YLR015W, YPR169W, YJR121W, YGL219C, YHL049C, YDL048C, YNL078W, YBR009C, YLR217W, YIL037C, YKL034W, YPR102c, YOR157c, YML045W, YBRO18C,

Iteration 2: YFR050C, YJL178C, YNL114C, YOR165W, YLR274W, YLR248W,

Iteration 3: YNL312W,

followed by YNL171C, YER040W, as generated in Step 8.

TABLE 8
First pass clustering for dimensionality reduction, based on gene ontology
study, on Yeast data (Set 2)

| | | | No. of |
|---|---|---|---|
| | | | Com- |
| | | | pressed |
| | | | clusters |
| Iteration | No. of clusters | Genes in each cluster | nₘ |
| | | 91, 15, 51, 168, 119, 39, 186, 73, | |
| | | 87, 86, 53, 92, 32, 24, | |
| | | 85, 112, 136, 125, 30, 90 | |
| 1 | √5775 = 76 | 7, 105, 55, 126, 61, 71, 12, | 32 |
| | | 18, 106, 60, 5, 89, 11, 138, 7, 112, | |
| | | 141, 122, 132, 87, | |
| | | 45, 97, 69, 47, 32, 95, 161, | |
| | | 2, 147, 14, 96, 112, 75, 18, 93, | |
| | | 10, 13, 12, 126, 162 | |
| | | 134, 93, 105, 150, 15, 96, 61, 48, | |
| | | 29, 70, 54, 10, 89, 4, 113, 119 | |
| | | 97, 14, 92, 66, 2, 41, 63, 67, 57, 61, | |
| | | 29, 137, 63, 86, 89, 77, 48, | |
| | | 121, 33, 63, | |
| 2 | √5775 − 1474 = 66 | 93, 71, 7, 88, 43, 16, 69, 100, | 6 |
| | | 78, 59, 59, 102, 2, 4, 74, 70, 25, | |
| | | 31, 87, 19, | |
| | | 70, 89, 11, 64, 85, 56, 74. 60, | |
| | | 7, 68, 85, 72, 87, 72, 75, 142, | |
| | | 50, 91, 71, 76, | |
| | | 83, 60, 68, 125, 80, 77 | |
| | | 62, 147, 12, 82, 48, 116, 37, 64, | |
| | | 73, 67, 51, 68, 48, 74, 125, 2, 51, | |
| | | 60, 98, 83, | |
| 3 | √4301 − 257 = 64 | 16, 2, 76, 28, 14, 77, 117, 79, 110, | 1 |
| | | 13, | |
| | | 78, 72, 69, 47, 47, 74, 6, 108, | |
| | | 39, 42, 67, 39, 47, 86, 87, 70, 82, | |
| | | 99, 40, 72, 59, 65, 91, 34 | |

Next these 41 genes are selected as the reduced set for the second stage of clustering in Table 9. It is observed that the partitioning corresponding to five clusters is biologically meaningful as evident from the cell-cycle data of Table 7.

TABLE 9
Second pass clustering using validity index for Yeast Data (Set 2)

| | Davies- | |
|---|---|---|
| No. of | Bouldin | Time points in |
| clusters | Index | each cluster |
| 2 | 0.84 | {1-18, 20, 25, 27- |
| | | 30, 39-40, 44- |
| | | 50, 52-60}, |
| | | {19, 21-24, 31- |
| | | 38, 41-43, 51}, |
| | | {1-20, |
| | | 26, 36, 38, 45- |
| | | 51, 60}, |
| 3 | 1.14 | {32-31, 33, 40- |
| | | 44, 52-59}, |
| | | {21-25, 27, 32, 34- |
| | | 35, 37, 39} |
| | | {7, 19, 26, 36, 47- |
| | | 54}, |
| 4 | 1.05 | {1-6, 7-18, 20, 45- |
| | | 46, 58, 60}, |
| | | {28-31, 33- |
| | | 34, 41-44, 55-57}, |
| | | {21- |
| | | 25, 27, 32, 35, 37- |
| | | 40, 59} |
| | | {1-18, 20, 26, 45- |
| | | 46}, |
| 5 | 0.08 | {19, 47-54}, |
| | | {28-31, 33-34, 41- |
| | | 44, 55-57}, |
| | | {58-59}, {21- |
| | | 25, 27, 32, 35-40} |
| | | {58-60}, |
| 6 | 0.90 | {29-31, 41- |
| | | 44, 46, 54-57}, |
| | | {23, 25, 27- |
| | | 28, 32, 35, 37, 39- |
| | | 40}, |
| | | {1- |
| | | 18, 20, 45}, {9, 47- |
| | | 53}, |
| | | {21-22, 24, 26, 33- |
| | | 34, 36, 38} |
| | | {20, 28- |
| | | 29, 33, 36, 40- |
| | | 43, 46, 52-57}, |
| 7 | 0.97 | {58-60}, {1-4}, |
| | | {22-27, 32, 35, 37- |
| | | 40}, |
| | | {7-11, 16-18, 45}, |
| | | {5, 12-15, 21, 30- |
| | | 31, 34}, {47-51} |
| | | {19, 21, 23, 34-35}, |
| 8 | 0.95 | {22, 24, 36, 38}, |
| | | {20, 29-31, 33, 41- |
| | | 42}, {3-7}, |
| | | {1 -2, 8-18}, {58- |
| | | 60}, |
| | | {28, 43, 46- |
| | | 57}, {25- |
| | | 27, 32, 37, 39-40} |

TABLE 10
Comparative study on clustering validity index in Eisen data (Set 2)

| | Reduced | Original |
|---|---|---|
| No. of | feature | feature |
| clusters | space | space |
| 2 | 0.84 | 3.00 |
| 3 | 1.14 | 6.44 |
| 4 | 1.05 | 4.48 |
| 5 | 0.08 | 18.06 |
| 6 | 0.90 | 5.41 |
| 7 | 0.97 | 4.77 |
| 8 | 0.95 | 6.25 |

TABLE 11
Comparative study on clustering time points in Eisen data (Set 2)

| | Reduced | |
|---|---|---|
| | feature | |
| Cluster no. | space | Original feature space |
| 5 | {1- | {22, 24, 36}, |
| | 18, 20, 26, 45- | |
| | 46}, | |
| | {21- | {1, 13,19-21, 26, 29, 34- |
| | 25, 27, 32, 35-40} | 35, 38, 40-43}, |
| | {28-31, 33-34, | {3-4, 11, 14, 16, 27- |
| | 41-44, 55-57}, | 28, 30, 46-50, 57, 60}, |
| | {19, 47-54}, | {6, 8, 10, 12, 18, 33, 44- |
| | | 45, 53-54}, |
| | {58-59}, | {2, 5, 7, 9, 15, 17, 23, 25, 31- |
| | | 32, 37, 39, 51-52, 55- |
| | | 56, 58-59} |

Biological knowledge, in terms of gene ontology, has been incorporated for an efficient two-way clustering of gene expression data. Handling of high-dimensional data requires a judicious selection of attributes. Feature selection therefore is important for such data analysis. Algorithm CLARANS was employed for attribute clustering to automatically extract the biologically relevant cluster prototypes. Subsequent partitioning in the reduced search space, at the second level, resulted in the generation of “good quality” clusters of gene expression profiles. Extraction of subspaces from the high-dimensional gene space lead to reduced computational complexity, improved visualization and faster convergence. These approaches should be useful for biologists to interpret and analyze subspaces according to their requirements.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

The present disclosure is not to be limited in terms of particular embodiments described in this disclosure, which are illustrations of various aspects. Many modifications and variations can be made without departing from the spirit and scope of the disclosure, as will be apparent to those skilled in the art. Functionally equivalent methods and apparatuses within the scope of the disclosure, in addition to those enumerated herein, will be apparent to those skilled in the art from the foregoing descriptions. Such modifications and variations fall within the scope of the appended claims. The present disclosure is to be limited only by the terms of claims (e.g., the claims appended hereto) along with the full scope of equivalents to which such claims are entitled. It is to be understood that this disclosure is not limited to particular methods, reagents, compounds compositions or biological systems, which can, of course, vary. It is also to be understood that terminology used herein is for the purpose of describing particular embodiments only, and is not necessarily limiting.

With respect to the use of substantially any plural and/or singular terms herein, those having skill in the art can translate from the plural to the singular and/or from the singular to the plural as is appropriate to the context and/or application. Various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

The term “about” as used herein refers to a value within 10% of the underlying parameter (i.e., plus or minus 10%), and use of the term “about” at the beginning of a string of values modifies each of the values (i.e., “about 1, 2 and 3” refers to about 1, about 2 and about 3). For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

Thus, it should be understood that although the present technology has been specifically disclosed by representative embodiments and optional features, modification and variation of the concepts herein disclosed may be resorted to by those skilled in the art, and such modifications and variations are considered within the scope of this technology. As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not limiting, with the true scope and spirit of certain embodiments indicated by the following claims.

What is claimed is:

1. A method for reducing dimensionality of a data set comprising:
receiving a first data set and a second data set;
choosing a feature selection;
performing statistical analysis on the first data set by one or more algorithms based on the feature selection;
determining a statistical significance of the statistical analysis based on the second data set; and
generating a reduced data set representation based on the statistical significance.

2. The method of claim 1, wherein the first data set is selected from the group consisting of gene microarray expression data, gene ontology data, protein expression data, cell signaling data, cell cycle data, amino acid sequence data, nucleotide sequence data, protein structure data, and combinations thereof.

3. The method of claim 1, wherein the second data set is selected from the group consisting of microarray expression data, gene ontology data, protein expression data, cell signaling data, cell cycle data, amino acid sequence data, nucleotide sequence data, protein structure data, and combinations thereof.

4. The method of claim 1, wherein the first data set, second data set, or first data set and second data set are normalized.

5. The method of claim 1, wherein the feature selection is selected from the group consisting of genes, gene expression levels, florescence intensity, time, co-regulated genes, cell signaling genes, cell cycle genes, proteins, co-regulated proteins, amino acid sequence, nucleotide sequence, protein structure data, and combinations thereof.

6. The method of claim 1, wherein the one or more algorithms performing the statistical analysis is selected from the group consisting of data clustering, multivariate analysis, artificial neural network, expectation-maximization algorithm, adaptive resonance theory, self-organizing map, radial basis function network, generative topographic map and blind source separation.

7. The method of claim 6, wherein the algorithm is a data clustering algorithm selected from the group consisting of CLARANS, PAM, CLATIN, CLARA, DBSCAN, BIRCH, OPTICS, WaveCluster, CURE, CLIQUE, K-means algorithm, and hierarchical algorithm.

8. The method of claim 7, wherein the clustering algorithm is CLARANS, the first data set is gene microarray expression data, the second data set is gene ontology data, and the feature selection is genes.

9. The method of claim 1, wherein the statistical significance is determined by a calculation selected from the group consisting of comparing means test decision tree, counternull, multiple comparisons, omnibus test, Behrens-Fisher problem, bootstrapping, Fisher's method for combining independent tests of significance, null hypothesis, type I error, type II error, exact test, one-sample Z test, two-sample Z test, one-sample t-test, paired t-test, two-sample pooled t-test having equal variances, two-sample unpooled t-test having unequal variances, one-proportion z-test, two-proportion z-test pooled, two-proportion z-test unpooled, one-sample chi-square test, two-sample F test for equality of variances, confidence interval, credible interval, significance, meta analysis or combination thereof.

10. The method of claim 1, wherein the statistical significance is measured by a p-value, which is the probability for finding at least k genes from a particular category within a cluster of size n, where f is the total number of genes within a category and g is the total number of genes within the genome in the equation:

11. The method of claim 1, wherein the performing the statistical analysis and the determining the statistical significance are repeated after the determining the statistical significance until substantially all of the first data set has been analyzed.

12. The method of claim 1, further comprising repeating the choosing the feature selection, the performing the statistical analysis and the determining the statistical significance at least once after completion of the generating the reduced data set representation, wherein a different feature selection is chosen.

13. The method of claim 1, further comprising after the determining the statistical significance, identifying outliers from the first data set and repeating the performing the statistical analysis and determining the statistical significance at least once or until substantially all of the outliers have been analyzed.

14. The method of claim 1, wherein a reduced data set representation is selected from the group consisting of digital data, a graph, a 2D graph, a 3D graph, and 4D graph, a picture, a pictograph, a chart, a bar graph, a pie graph, a diagram, a flow chart, a scatter plot, a map, a histogram, a density chart, a function graph, a circuit diagram, a block diagram, a bubble map, a constellation diagram, a contour diagram, a cartogram, spider chart, Venn diagram, nomogram, and combination thereof.

15. The method of claim 1, further comprising, after the performing the statistical analysis, validating the statistical analysis on the first data set.

16. The method of claim 1, further comprising, after the generating the reduced data set representation, validating the reduced data set representation with an algorithm.

17. The method of claim 13, further comprising validating the analyzed outliers.

18. The method of claim 16, wherein the algorithm is selected from the group consisting of Silhouette Validation method, C index, Goodman-Kruskal index, Isolation index, Jaccard index, Rand index, Class accuracy, Davies-Bouldin index, Xie-Beni index, Dunn separation index, Fukuyama-Sugeno measure, Gath-Geva index, Beta index, Kappa index, Bezdek partion coefficient or a combination thereof.

19. An apparatus that reduces the dimensionality of a data set comprising a programmable processor that implements a data set dimensionality reducer wherein the reducer implements a method comprising:
receiving a first data set and a second data set;
choosing a feature selection;
performing statistical analysis on the first data set by one or more algorithms based on choice of the feature selection;
determining a statistical significance of the statistical analysis based on the second data set; and
generating a reduced data set representation based on the statistical significance.

20. A computer program product, comprising a computer usable medium having a computer readable program code embodied therein, the computer readable program code adapted to be executed to implement a method for generating a reduced data set representation, the method comprising:
receiving, by a logic processing module, a first data set and a second data set;
choosing by a data organization module a feature selection;
performing by the logic processing module statistical analysis on the first data set utilizing one or more algorithms based on the feature selection;
determining by the logic processing module a statistical significance of the statistical analysis based on the second data set; and
generating by a data display organization module a reduced data set representation based on the statistical significance.
